(19) United States
(12) Patent Application Publication
(10) Pub. No.: US 2026/0212536 A1
(43) Pub. Date: Jul. 23, 2026

(54) Local Coding of Point Cloud Attributes

(71) Applicant: Ofinno, LLC, Reston, VA (US)

(72) Inventors: Jonathan Taquet, Talensac (FR); Sébastien Lasserre, Thorigné-Fouillard (FR)

(73) Assignee: Ofinno, LLC, Reston, VA (US)

(21) Appl. No.: 19/448,725

(22) Filed: Jan. 14, 2026

Related U.S. Application Data
(63) Continuation of application No. PCT/US2024/038032, filed on Jul. 15, 2024.
(60) Provisional application No. 63/526,782, filed on Jul. 14, 2023.

(51) Int. Cl. G06T 9/00

(52) U.S. Cl. CPC G06T 9/001

(57) ABSTRACT

Attribute coding unit (ACU) information is decoded from a bitstream. The ACU information indicates a segmentation of a reconstructed geometry of a slice, of slices of TriSoup nodes representing a geometry of a point cloud, into at least a set of ACUs. An ACU, of the set of ACUs, corresponds to at least one TriSoup node of TriSoup nodes of the slice. According to the ACU information, the reconstructed geometry of the slice of the point cloud is segmented into the set of ACUs with each of the ACUs comprises at least one point of the point cloud. Attributes of points, of the point cloud, belonging to a current ACU of the set of ACUs are decoded before attributes of points, of the point cloud, belonging to another ACU of the set of ACUs are decoded.

### CROSS-REFERENCE TO RELATED APPLICATIONS

This application is a continuation of International Application No. PCT/US2024/038032, filed Jul. 15, 2024, which claims the benefit of U.S. Provisional Application No. 63/526,782, filed Jul. 14, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary point cloud coding/decoding system in which embodiments of the present disclosure may be implemented.

FIG. 2 illustrates the Morton order of eight sub-cuboids split from a cuboid.

FIG. 3 illustrates an example processing or scanning order for the first three level of an occupancy tree.

FIG. 4 illustrates an example of already-coded occupancies of cuboids that may be used to code the occupancy of a current child cuboid.

FIG. 5 illustrates an example of a dynamic reduction function DR that may be used in dynamic OBUF.

FIG. 6 illustrates a flowchart of an example method for coding the occupancy (e.g., as indicated by a single bit) of a current child cuboid using dynamic OBUF.

FIG. 7 illustrates an example of an occupied cube of size N×N×N (where N>1) that corresponds to a TriSoup node of an occupancy tree.

FIG. 8A illustrates an example cube corresponding to a TriSoup node with a number K of TriSoup vertices Vₖ.

FIG. 8B illustrates an example refinement to the TriSoup model by coding a centroid residual value Cᵣₑₛ into the bitstream such as to use C+Cᵣₑₛ instead of C as pivoting vertex for the triangles.

FIG. 9 illustrates an example of voxelization.

FIG. 10 illustrates a diagram of an example encoding process using inter frame prediction between point clouds.

FIG. 11 illustrates a diagram of an example process for encoding point cloud attributes based on a prediction transform scheme.

FIG. 12 illustrates a diagram of an example process for decoding point cloud attributes based on a prediction transform scheme.

FIG. 13 illustrates a diagram of an example process for encoding point cloud attributes based on a prediction with lifting (pred-lift) transform scheme.

FIG. 14 illustrates a diagram of an example process for decoding point cloud attributes based on a prediction with lifting (pred-lift) transform scheme.

FIG. 15 illustrates an example region adaptive hierarchical transform (RAHT) transformation applied to child nodes of an octree parent node along three successive directions.

FIG. 16 illustrates an example of the RAHT transformation being applied to all octree nodes at depth ‘d’ to determine DC coefficients at depth d−1 and AC coefficients.

FIG. 17 illustrates a raster scan ordering of an octree.

FIG. 18 illustrates an example octree at the last depth with only occupied nodes being shown.

FIG. 19 illustrates an example octree at the last depth with only occupied nodes being shown.

FIG. 20. illustrates an example progression of coding for both octree and TriSoup processes, in which a slice N is being coded by the octree process.

FIG. 21 illustrates an example process for encoding geometry and attributes of a point cloud using a TriSoup geometry scheme.

FIG. 22 illustrates an example process for decoding geometry and attributes of a point cloud using a TriSoup geometry scheme.

FIG. 23 illustrates an example process for encoding geometry and attributes of a point cloud, according to some embodiments.

FIG. 24 illustrates an example process for decoding geometry and attributes of a point cloud, according to some embodiments.

FIG. 25 illustrates an example process for encoding geometry and attributes of a point cloud in accordance, according to some embodiments.

FIG. 26 illustrates an example process for decoding geometry and attributes of a point cloud in accordance, according to some embodiments.

FIG. 27 illustrates an example process for encoding geometry and attributes of a point cloud, according to some embodiments.

FIG. 28 illustrates an example process for decoding geometry and attributes of a point cloud using a TriSoup geometry scheme, according to some embodiments.

FIG. 29 illustrates an example process for encoding attributes of an ACU, according to some embodiments.

FIG. 30 illustrates an example process for decoding attributes of an ACU, according to some embodiments.

FIG. 31 illustrates an example process for encoding attributes of an ACU, according to some embodiments.

FIG. 32 illustrates an example process for decoding attributes of an ACU, according to some embodiments.

FIG. 33 illustrates an example process for inter encoding attributes of a current ACU, according to some embodiments.

FIG. 34 illustrates an example process for inter decoding attributes of a current ACU, according to some embodiments.

FIG. 35 illustrates a flowchart 3500 of an example method for encoding attributes of a point cloud frame (e.g., a current point cloud frame), according to some embodiments.

FIG. 36 illustrates a flowchart 3600 of an example method for decoding attributes of a point cloud frame (e.g., a current point cloud frame), according to some embodiments.

FIG. 37 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of points that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color, reflectance, time stamp, etc. Compared to traditional visual data, volumetric visual data may provide a more immersive way to experience visual data.

For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Sparse volumetric visual data may be used in the automotive industry for the representation of 3D maps (cartography) or as input to assisted driving systems. In the latter use case, volumetric visual data is typically input to driving decision algorithms. In another example, volumetric visual data may be used to store valuable objects in digital form. In applications for preserving cultural heritage, the goal is to keep a representation of objects that may be threatened by natural disasters. For example, statues, vases, and temples may be entirely scanned and stored as volumetric visual data having several billions of samples. This use case for volumetric visual data may be particularly relevant for valuable objects in locations where earthquakes, tsunamis, and typhoons are frequent. Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is point clouds. A point cloud comprises a collection of points in three-dimensional (3D) space. Each point in a point cloud may comprise geometry information that indicates the point's position in 3D space. For example, the geometry information may indicate the point's position in 3D space using three Cartesian coordinates (x, y, and z) or using spherical coordinates (r, phi, theta) (e.g., when acquired by a rotating sensor). The positions of points in a point cloud may be quantized according to a space precision, which may be the same or different in each dimension. The quantization process may create a grid in 3D space. One or more points residing within each sub-grid volume may be mapped to the sub-grid center coordinates, referred to as voxels. A voxel may be considered as a 3D extension of pixels corresponding to the 2D image grid coordinates. For example, similar to a pixel being the smallest unit when dividing the 2D space (or 2D image) into discrete, uniform (e.g., equally sized) regions, a voxel may be the smallest unit of volume when dividing 3D space into discrete, uniform regions. The sub-grid center coordinates (which correspond to voxels) may be referred to as a voxelized grid. A point in a point cloud may further comprise one or more types of attribute information. Attribute information may indicate a property of a point's visual appearance. For example, attribute information may indicate a texture (e.g., color of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). In another example, a point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer or may be generated from the capture of a real-world object or scene. The geometry information of a real-world object or scene may be determined by 3D scanning and/or photogrammetry. 3D scanning may include laser scanning, structured light scanning, and/or modulated light scanning. 3D scanning may determine geometry information by moving one or more laser heads, structured light cameras, and/or modulated light cameras relative to an object or scene being scanned. Photogrammetry may determine geometry information by triangulating the same feature or point in different spatially shifted 2D photographs. Point cloud data may be in the form of a point cloud frame that describes an object or scene captured at a particular time instance or in the form of a sequence of point cloud frames (referred to as a point cloud sequence or point cloud video) that describes an object or scene captured at multiple different time instances.

The data size of a point cloud frame or sequence may be too large for storage and/or transmission in many applications. For example, a single point cloud may comprise over a million points or even billions of points, where each point may comprise geometry information and one or more optional types of attribute information. The geometry information of each point may comprise three Cartesian coordinates (x, y, and z) or spherical coordinates (r, phi, theta) that are each represented, for example, using at least 10 bits per component or 30 bits in total. The attribute information of each point may comprise a texture corresponding to three color components (e.g., R, G, and B color components) that are each represented, for example, using 8-10 bits per component or 24-30 bits in total. A single point therefore comprises at least 54 bits of information in this example, with at least 30 bits of geometry information and at least 24 bits of texture. If a point cloud frame includes a million such points, each point cloud frame would require 54 million bits or 54 megabits to represent. In case of dynamic point clouds that change over time, at a frame rate of 30 frames per second, a data rate of 1.62 gigabits per second would be required to transmit the points of the point cloud sequence. Therefore, raw representations of point clouds may require a large amount of data and the practical deployment of point-cloud-based technologies may need compression technologies that enable the storage and distribution of point clouds with reasonable cost.

Encoding may be used to compress and/or reduce the data size of a point cloud frame or sequence to provide for more efficient storage and/or transmission. Decoding may be used to decompress a compressed point cloud frame or sequence for display and/or other forms of consumption (e.g., by a machine learning-based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, like medical applications or autonomous driving, may require lossless compression to avoid altering the results of a decision determined based on the analysis of the transmitted and decompressed point cloud frame.

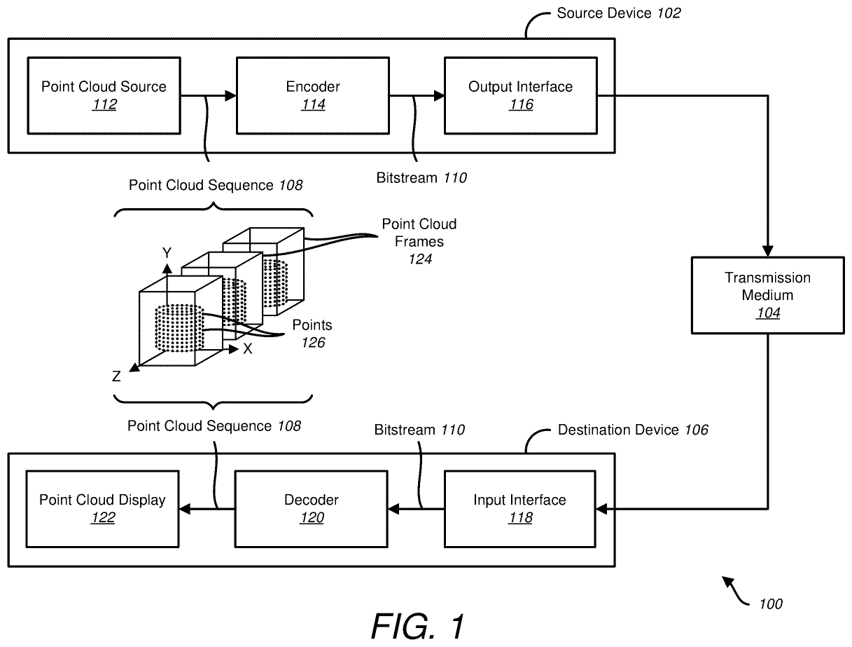

FIG. 1 illustrates an exemplary point cloud coding system 100 in which embodiments of the present disclosure may be implemented. Point cloud coding system 100 comprises a source device 102, a transmission medium 104, and a destination device 106. Source device 102 encodes a point cloud sequence 108 into a bitstream 110 for more efficient storage and/or transmission. Source device 102 may store and/or transmit bitstream 110 to destination device 106 via transmission medium 104. Destination device 106 decodes bitstream 110 to display point cloud sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode point cloud sequence 108 into bitstream 110, source device 102 may comprise a point cloud source 112, an encoder 114, and an output interface 116. Point cloud source 112 may provide or generate point cloud sequence 108 from a capture of a natural scene and/or a synthetically generated scene. A synthetically generated scene may be a scene comprising computer generated graphics. Point cloud source 112 may comprise one or more point cloud capture devices (e.g., one or more laser scanning devices, structured light scanning devices, modulated light scanning devices, and/or passive scanning devices), a point cloud archive comprising previously captured natural scenes and/or synthetically generated scenes, a point cloud feed interface to receive captured natural scenes and/or synthetically generated scenes from a point cloud content provider, and/or a processor to generate synthetic point cloud scenes.

As shown in FIG. 1, a point cloud sequence 108 may comprise a series of point cloud frames 124. A point cloud frame may describe an object or scene captured at a particular time instance. Point cloud sequence 108 may achieve the impression of motion when a constant or variable time is used to successively present point cloud frames 124 of point cloud sequence 108. A point cloud frame may comprise a collection of points 126 in 3D space. Each of points 126 may comprise geometry information that indicates the point's position in 3D space. For example, the geometry information may indicate the point's position in 3D space using three Cartesian coordinates (x, y, and z). One or more of points 126 may further comprise one or more types of attribute information. Attribute information may indicate a property of a point's visual appearance. For example, attribute information may indicate a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying). In another example, one or more of points 126 may comprise light field data in the form of multiple view-dependent texture information. Light field data may be another type of optional attribute information. Color attribute information of one or more of points 126 may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

Encoder 114 may encode point cloud sequence 108 into bitstream 110. To encode point cloud sequence 108, encoder 114 may apply one or more lossy compression techniques and/or prediction techniques to reduce redundant information in point cloud sequence 108. Redundant information is information that may be predicted at a decoder and therefore may not be needed to be transmitted to the decoder for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization by quantizing positions of points in a point cloud, which creates a grid in 3D space. The G-PCC reference software encoder may map the points to the center coordinates of the sub-grid volume (or voxel) that their quantized locations reside. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may apply a transform tool, such as Region Adaptive Hierarchical Transform (RAHT), the Predicting Transform, and/or the Lifting Transform. The Lifting Transform may be built on top of the Predicting Transform but with an extra update/lifting step. Consequently, these two transforms may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104 for transmission to destination device 106. In addition, or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into point cloud sequence 108 for display or other forms of consumption, destination device 106 may comprise an input interface 118, a decoder 120, and a point cloud display 122. Input interface 118 may be configured to read bitstream 110 stored on transmission medium 104 by source device 102. In addition, or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode point cloud sequence 108 from encoded bitstream 110. For example, decoder 120 may operate in a same or similar manner to a decoder provided by G-PCC reference software. In some examples, decoder 120 may decode a point cloud sequence that approximates point cloud sequence 108 due to, for example, lossy compression of point cloud sequence 108 by encoder 114 and/or errors introduced into encoded bitstream 110 during transmission to destination device 106.

Point cloud display 122 may display point cloud sequence 108 to a user. Point cloud display 122 may comprise a cathode rate tube (CRT) display, a liquid crystal display (LCD), a plasma display, a light emitting diode (LED) display, a 3D display, a holographic display, a head mounted display, or any other display device suitable for displaying point cloud sequence 108.

It should be noted that point cloud coding/decoding system 100 is presented by way of example and not limitation. In the example of FIG. 1, point cloud coding/decoding system 100 may have other components and/or arrangements. For example, point cloud source 112 may be external to source device 102. Similarly, point cloud display 122 may be external to destination device 106 or omitted altogether where point cloud sequence is intended for consumption by a machine and/or storage device. In another example, source device 102 may further comprise a point cloud decoder and destination device 106 may comprise a point cloud encoder. In such an example, source device 102 may be configured to further receive an encoded bit stream from destination device 106 to support two-way point cloud transmission between the devices.

As mentioned above, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel. A voxel may be considered as a 3D extension of pixels corresponding to 2D image grid coordinates.

The encoder may represent or code the point cloud using an occupancy tree. For example, the encoder may split the initial volume or cuboid (also referred to as a bounding box) containing the point cloud into sub-cuboids. The encoder may then recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied cuboid into, for example, two sub-cuboids (to form a binary tree), four sub-cuboids (to form a quadtree), or eight sub-cuboids (to form an octree). The encoder may split an occupied cuboid to determine sub-cuboids all with the same size and shape at a given depth level of the occupancy tree by splitting following a plane passing through the middle of edges of the cuboid.

The initial volume or cuboid containing the point cloud may correspond to the root node of the occupancy tree. Each occupied sub-cuboid, split from the initial volume, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, some maximum depth level of the occupancy tree is reached or each occupied sub-cuboid has a volume corresponding to one voxel.

Each non-leaf node of the occupancy tree may comprise or be associated with an occupancy word representing an occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be represented or indicated by a binary 1 in the 1-byte occupancy word and unoccupied sub-cuboids may be represented or indicated by a binary 0 in the 1-byte occupancy word. In other examples, occupied and un-occupied sub-cuboids may be represented or indicated by opposite 1-bit binary values in the 1-byte occupancy word.

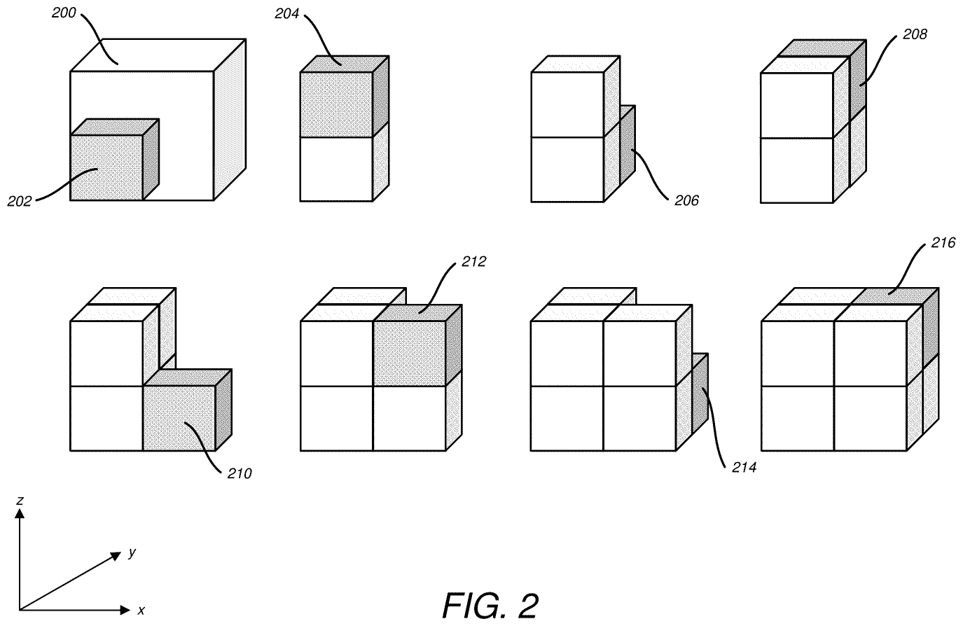

Each bit of an occupancy word may represent or indicate the occupancy of a different one of the eight sub-cuboids following the so-called Morton order. For example, the least significant bit of an occupancy word may represent or indicate the occupancy of a first one of the eight sub-cuboids following the Morton order, the second least significant bit of an occupancy word may represent or indicate the occupancy of a second one of the eight sub-cuboids following the Morton order, etc. FIG. 2 illustrates the Morton order of eight sub-cuboids 202-216 split from a cuboid 200. Sub-cuboids 202-216 are labeled based on their Morton order, with child node 202 being the first in Morton order and child node 216 being the last in Morton order. The Morton order for sub-cuboids 202-216 is a local lexicographic order in xyz.

The geometry of the point cloud is represented by, and therefore may be determined from, the initial volume and the occupancy words of the nodes in the occupancy tree. The encoder may therefore transmit the initial volume and the occupancy words of the nodes in the occupancy tree in a bitstream to a decoder for reconstructing the point cloud. Before transmitting the initial volume and the occupancy words of the nodes in the occupancy tree, the encoder may entropy encode the occupancy words. For example, the encoder may encode an occupancy bit of an occupancy word of a node corresponding to a cuboid, based on one or more occupancy bits of occupancy words of other nodes corresponding to cuboids that are adjacent or spatially close to the cuboid of the occupancy bit being encoded.

An encoder and/or decoder may code occupancy bits of occupancy words in sequence of a scan order. For example, an encoder and/or decoder may scan an occupancy tree in breadth-first order: all the occupancy words of the nodes of a given depth (or level) within the occupancy tree may be scanned before scanning the occupancy words of the nodes of the next depth (or level). Within a depth, the encoder and/or decoder may scan the occupancy words of nodes in the Morton order. Within a node, the encoder and/or decoder may scan the occupancy bits of the occupancy word of the node further in the Morton order.

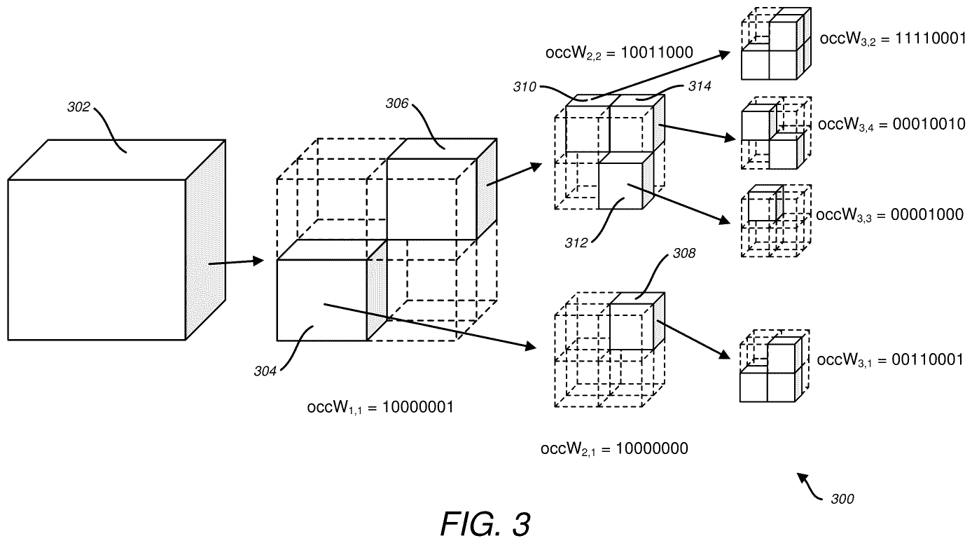

FIG. 3 illustrates an example of this scanning order for the first three levels of an occupancy tree 300. In FIG. 3, a cube 302 corresponding to the root node of occupancy tree 300 is divided into eight sub-cubes. Two sub-cubes 304 and 306 of the eight sub-cubes are occupied, while the other six sub-cubes are unoccupied. Following the Morton order, a first eight-bit occupancy word occW1,1 is constructed to represent the occupancy word of the root node. The least significant occupancy bit of the first eight-bit occupancy word occW1,1 represents or indicates the occupancy of the first sub-cube of the eight sub-cubes in Morton order, the second least significant occupancy bit of the first eight-bit occupancy word occW1,1 represents or indicates the occupancy of the second sub-cube of the eight sub-cubes in Morton order, etc.

Each of the two occupied sub-cubes 304 and 306 corresponds to a node off the root node in a second level of occupancy tree 300. The two occupied sub-cubes 304 and 306 are each further split into eight sub-cubes. One of the sub-cubes 308 of the eight sub-cubes split from sub-cube 304 is occupied, while the other seven sub-cubes are unoccupied. Three of the sub-cubes 310, 312, and 314 of the eight sub-cubes split from sub-cube 306 are occupied, while the other five sub-cubes of the eight sub-cubes split from sub-cube 306 are unoccupied. Two second eight-bit occupancy words occW2,1 and occW2,2 are constructed in this order to respectively represent the occupancy word of the node corresponding to sub-cube 304 and the occupancy word of the node corresponding to sub-cube 306.

Each of the four occupied sub-cubes 308, 310, 312, and 314 corresponds to a node in a third level of occupancy tree 300. The four occupied sub-cubes 308, 310, 312, and 314 are each further split into eight sub-cubes or 32 sub-cubes in total. Four third eight-bit occupancy words occW3,1, occW3,2, occW3,3 and occW3,4 are constructed in this order to respectively represent the occupancy word of the node corresponding to sub-cube 308, the occupancy word of the node corresponding to sub-cube 310, the occupancy word of the node corresponding to sub-cube 312, and the occupancy word of the node corresponding to sub-cube 314.

Following the scanning order discussed above, the occupancy words of this exemplary occupancy tree 300 may be entropy coded (e.g., entropy encoded by an encoder and entropy decoded by a decoder) as the succession of the seven occupancy words occW1,1 to occW3,4. As a consequence of the breadth-first scanning order, when entropy coding the occupancy word of a current child node belonging to a current parent node, the occupancy words of all nodes having the same depth (or level) as the current parent node have already been entropy coded. In addition, the occupancy words of all nodes having the same depth (or level) as the current child node and having a lower Morton order than the current child node have also already been entropy coded. Part of these already coded occupancy words may be used to entropy code the occupancy word of the current child node. For example, the already coded occupancy words of neighboring parent and child nodes may be used to entropy code the occupancy word of the current child node. When entropy coding a particular occupancy bit of the occupancy word of the current child node, the occupancy bits of the occupancy word having a lower Morton order than the particular occupancy bit have also already been entropy coded and may be used to code the occupancy bit of the occupancy word of the current child node.

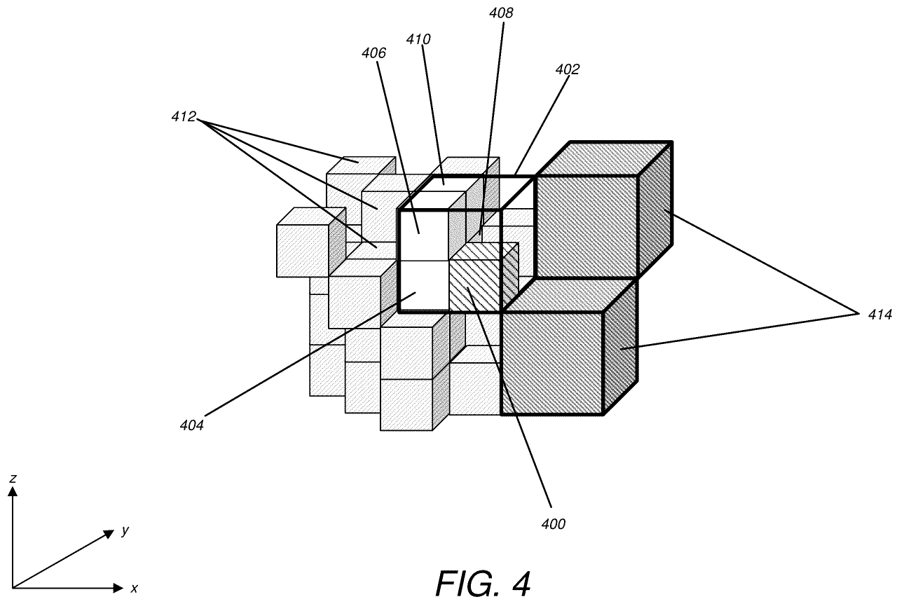

FIG. 4 illustrates an example neighborhood of cuboids with already-coded occupancy bits that may be used to entropy code the occupancy bit of a current child cuboid 400. The neighborhood of cuboids with already-coded occupancy bits may be determined based on the scanning order of an occupancy tree representing the geometry of the cuboids in FIG. 4 as discussed above. As illustrated in FIG. 4, current child cuboid 400 belongs to a current parent cuboid 402. Following the scanning order of the occupancy words and occupancy bits of nodes of the occupancy tree, the occupancy bits of four child cuboids 404, 406, 408, and 410, belonging to the same current parent cuboid 402, have already been coded. Also, the occupancy bit of child cuboids 412 of preceding parent cuboids have already been coded. Furthermore, the occupancy bits of parent cuboids 414, for which the occupancy bits of child cuboids have not already been coded, have already been coded. Therefore, the already-coded occupancy bits of cuboids 404, 406, 408, 410, 412, and 414 may be used to code the occupancy bit of the current child cuboid 400.

The number of possible occupancy configurations for a neighborhood of a current child cuboid may be 2N, where N is the number of cuboids in the neighborhood of the current child cuboid with already-coded occupancy bits. The neighborhood of the current child cuboid may comprise several dozens of cuboids, among them the 26 adjacent parent cuboids sharing a face, an edge, or a vertex with the parent cuboid of the current child cuboid and also several adjacent child cuboids sharing a face, an edge, or a vertex with the current child cuboid. Even limited to a subset of the adjacent cuboids, the occupancy configuration for a neighborhood of the current child cuboid may have billions of possible occupancy configurations making its direct use impractical. The occupancy configuration for a neighborhood of the current child cuboid may be used by an encoder and/or decoder to select the context (or equivalently the probability model), among a set of contexts, of a binary entropy coder (e.g., binary arithmetic coder) that codes the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC).

Several methods may be used by an encoder and/or decoder to reduce the occupancy configurations for a neighborhood of a current child cuboid being coded to a practical number of reduced occupancy configurations. Firstly, the 26 or 64 occupancy configurations of the six adjacent parent cuboids sharing a face with the parent cuboid of the current child cuboid may be reduced to nine occupancy configurations by using geometry invariance. Secondly, an occupancy score for the current child cuboid may be determined from the 226 occupancy configurations of the 26 adjacent parent cuboids. The score may be further reduced into a ternary occupancy prediction (“predicted occupied”, “unsure”, “predicted unoccupied”) by applying score thresholds. Thirdly, the number of occupied and the number of unoccupied adjacent child cuboids may be used instead of the individual occupancies of these child cuboids.

An encoder and/or decoder employing one or more of the above methods may reduce the number of possible occupancy configurations for a neighborhood of a current child cuboid to a more manageable number (e.g., a few thousands). However, it has been observed that instead of associating a reduced number of contexts (or probability models) directly to the reduced occupancy configurations, another mechanism may be used, namely Optimal Binary Coders with Update on the Fly (OBUF). An encoder and/or decoder may implement OBUF to limit the number of contexts to a lower number (e.g., 32 contexts).

OBUF may use a limited number (e.g., 32) of contexts that may be fixed. These contexts may be ordered, referred to by a context index (e.g., a context index in the range of 0 to 31), and associated from a lowest virtual probability to a highest virtual probability to code a 1. A Look-Up Table (LUT) of context indices may be initialized at the beginning of a point cloud coding process. For example, the LUT may initially point to a context (e.g., context with context index 15), among the limited number of contexts, with the median virtual probability to code a 1 for all input. This LUT may take an occupancy configuration for a neighborhood of current child cuboid as input and output the context index associated with the occupancy configuration. Consequently, the LUT may have as many entries as reduced occupancy configurations (e.g., around a few thousand). The coding of the occupancy bit of a current child cuboid may follow the steps of determining the reduced occupancy configuration of the current child node, determining a context index by applying the reduced occupancy configuration as an entry to the LUT, coding the occupancy bit of the current child cuboid by using the context pointed to (or indicated) by the context index, and finally updating the LUT entry corresponding to the reduced occupancy configuration depending on the value of the coded occupancy bit of the current child cuboid. If a binary 0 (e.g., indicating the current child cuboid is unoccupied) is coded, the LUT entry may be decreased to a lower context index value, and if a binary 1 (e.g., indicating the current child cuboid is occupied) is coded, the LUT entry may be increased to a higher context index value. The update process of the context index may be based on a theoretical model of optimal distribution for virtual probabilities associated with the limited number of contexts. This virtual probability for a context may be fixed by a model and may be different from the internal probability of the context that evolves during the coding of bits of data. The evolution of the internal context may follow a well-known process similar to the process in CABAC.

An encoder and/or decoder may implement a “dynamic OBUF” scheme that may handle a much larger number of occupancy configurations for a neighborhood of a current child cuboid than can be handled by general OBUF, while maintaining complexity within reasonable bounds. The use of a larger number of occupancy configurations for a neighborhood of a current child cuboid may lead to improved compression capabilities. By using an occupancy tree compressed by OBUF, an encoder and/or decoder may reach a lossless compression performance as good as 1 bit per point (bpp) for coding the geometry of dense point clouds. An encoder and/or decoder may implement dynamic OBUF to potentially further reduce the bitrate by more than 25% to 0.7 bpp.

OBUF may not take as input a large variety of reduced occupancy configurations for a neighborhood of a current child cuboid, thus potentially leading to a loss of useful correlation. The size of the LUT of context indices may be increased to handle more various occupancy configurations for a neighborhood of a current child cuboid as input. However, by doing so, statistics may be diluted, and compression performance may be reduced. For example, if the LUT has millions of entries and the point cloud has a hundred thousand points, then most of the entries are never visited. Worse yet, many entries may be visited only a few times and their associated context indices may not be updated enough times to reflect any meaningful correlation between the occupancy configuration value and the probability of occupancy of the current child cuboid. Dynamic OBUF may be implemented to mitigate the dilution of statistics due to the increase in the number of occupancy configurations for a neighborhood of a current child cuboid. This mitigation is performed by a “dynamic reduction” of occupancy configurations in dynamic OBUF.

Dynamic OBUF may add an extra step of reduction of occupancy configurations for a neighborhood of a current child cuboid before applying the LUT of context indices. This step may be called a dynamic reduction because it evolves based on the progress of the coding of the point cloud or, more precisely, based on already visited occupancy configurations.

As discussed above, many possible occupancy configurations for a neighborhood of a current child cuboid are potentially involved but only a subset may be visited during the coding of a point cloud. This subset may characterize the type of the point cloud. For example, when coding AR or VR dense point clouds, most of the visited occupancy configurations may exhibit occupied adjacent cuboids of a current child cuboid. On the other hand, when coding sensor-acquired sparse point clouds, most of the visited occupancy configurations may exhibit only a few occupied adjacent cuboids of a current child cuboid. The role of the dynamic reduction may be to determine a more precise correlation based on the most visited occupancy configuration while putting aside (or reducing aggressively) other occupancy configurations that are much less visited. The dynamic reduction may be updated on-the-fly, as detailed below, after each visit of an occupancy configuration during the coding of occupancy data.

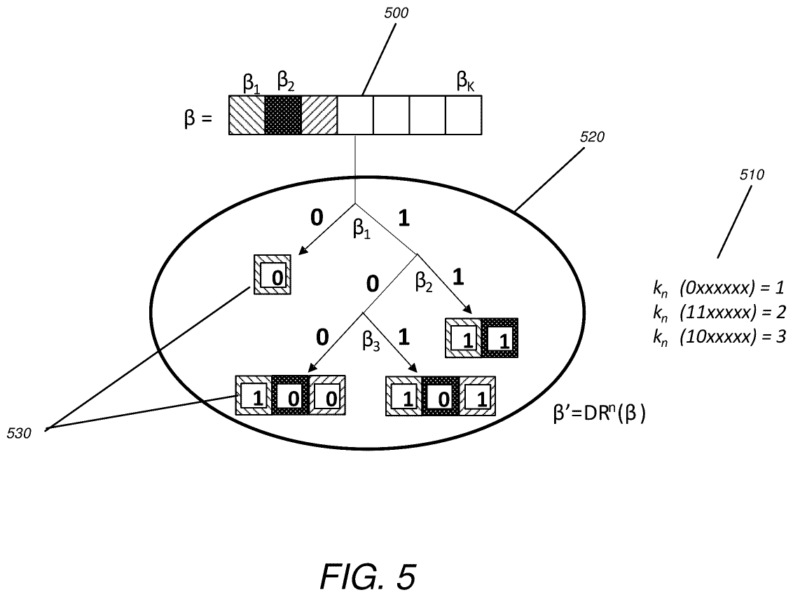

FIG. 5 illustrates an example of a dynamic reduction function DR that may be used in dynamic OBUF. The dynamic reduction function DR may be determined by masking bits βⱼ of occupancy configurations 500

$$β - β 1 … β K$$

made of K bits. The size of the mask may decrease when occupancy configurations are visited a certain number of times. The initial dynamic reduction function DR0 may mask all bits for all occupancy configurations such that it is a constant function DR0(β)=0 for all occupancy configurations B. After each coding of an occupancy bit, the dynamic reduction function may evolve from a function DRn to an updated function DRn+1. The function may be defined by

$${β}^{′} = DRn ( β ) = β 1 … β kn ( β )$$

where kₙ(β) 510 is the number of non-masked bits. The initialization of DR⁰ may correspond to k₀(β)=0, and the natural evolution of the reduction function towards finer statistics may lead to an increasing number of non-masked bits kₙ(β)≤kₙ₊₁(β). The dynamic reduction function may be entirely determined by the values of kₙ for all occupancy configurations β.

The visits to occupancy configurations may be tracked by a variable NV(β′) for all dynamically reduced occupancy configurations β′=DRⁿ(β). After the coding of an occupancy bit based on an occupancy configuration BV, the corresponding number of visits NV(β^{V′}) may be increased by one. If this number of visits NV(β^{V′}) is greater than a threshold th_{V},

$$NV ( {β}^{V ′} ) > {th}_{V}$$

then the number of unmasked bits kₙ(β) may be increased by one for all occupancy configurations β being dynamically reduced to β^{V′}. Practically, this corresponds to replacing the dynamically reduced occupancy configuration β^{V′} by the two new dynamically reduced occupancy configurations β^{0′} and β^{1′} defined by

$${β}^{0 ′ =} {β}^{V ′} 0 = {β}_{1}^{V} … {β}_{kn ( β )}^{V} 0 and {β}^{1 ′} = {β}^{V ′} 1 = {β}_{1}^{V} … {β}_{kn ( β )}^{V} 1.$$

In other words, the number of unmasked bits has been increased by one kₙ₊₁(β)=kₙ(β)+1 for all occupancy configurations β such that DRⁿ(β)=β^{V′}. The number of visits of the two new dynamically reduced occupancy configurations may then be initialized to zero

$$NV ( {DR}^{0} ( β ) ) = NV ( 0 ) = 0 ,$$

At the start of the coding, the initial number of visits for the initial dynamic reduction function DR⁰ may be set to

$$NV ( {DR}^{0} ( β ) ) = NV ( 0 ) = 0 ,$$

and the evolution of NV on dynamically reduced occupancy configurations may now be entirely defined.

When a dynamically reduced occupancy configuration β^{V′} is replaced by the two new dynamically reduced occupancy configurations β^{0′} and β^{1′}, the corresponding LUT entry LUT[β^{V′}] may be replaced by the two new entries LUT[β^{0′}] and LUT[β^{1′}] that are initialized by the context index associated with β^{V″},

$$LUT [ {β}^{0 ′} ] = LUT [ {β}^{1 ′} ] = LUT [ {β}^{V ′} ] , \qquad ( II )$$

and then evolve separately. The evolution of the LUT of context indices on dynamically reduced occupancy configurations may thus be entirely defined.

The reduction function DRn may be modeled by a series of growing binary trees Tn 520 whose leaf nodes 530 are the reduced occupancy configurations β′=DRn(β). The initial tree may be the single root node associated with 0=DR0(β). The replacement of the dynamically reduced to βV′ by β0′ and β1′ corresponds to growing the tree In from the leaf node associated with βV′ by attaching to it two new nodes associated with β0′ and β1′. The tree Tn+1 may be determined by this growth. The number of visits NV and the LUT of context indices may be defined on the leaf nodes and evolve with the growth of the tree through equations (I) and (II).

In some examples, dynamic OBUF may be practically implemented by storage of the array NV[β′] and the LUT[β′] of context indices, as well as the trees Tn 520. An alternative to the storage of the trees may be to store the array kn[β] 510 of the number of non-masked bits.

A limitation for implementing dynamic OBUF may be its memory footprint. In some applications, a few million occupancy configurations may be practically handled, leading to about 20 bits βi constituting an entry configuration β to the reduction function DR. Each bit βi may correspond to the occupancy status of a neighboring cuboid of a current child cuboid or a set of neighboring cuboids of a current child cuboid.

Higher bits βi (e.g. β0, β1, etc.) may be the first bits to be unmasked during the evolution of the dynamic reduction function DR. Therefore, the order of neighbor-based information put in the bits βi may impact the compression performance. In some examples, neighboring information may be ordered from highest priority to lower priority and put in this order into the bits βi, from higher to lower weight. For example, the priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge or, worse, only a vertex with the current child node.

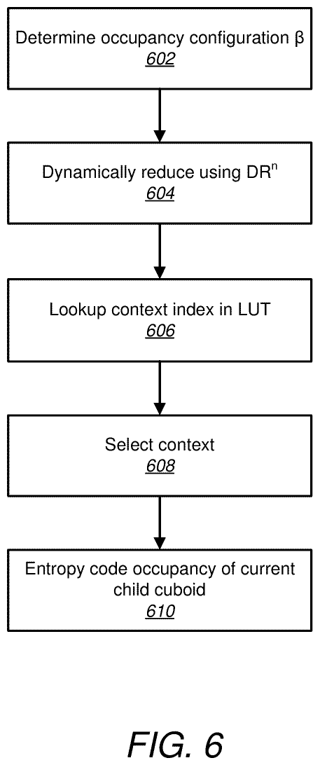

FIG. 6 illustrates a flowchart of an exemplary method for coding the occupancy bit of a current child cuboid using dynamic OBUF. The method of the flowchart begins at block 602. At block 602, an encoder and/or decoder may determine the occupancy configuration β of already-coded cuboids in a neighborhood of the current child cuboid. At block 604, the encoder and/or decoder may dynamically reduce the occupancy configuration β into a reduced occupancy configuration β′=DRn(β). At block 606, the encoder and/or decoder may lookup context index LUT[β′] in the LUT of the dynamic OBUF. At block 608, the encoder and/or decoder may select the context (or probability model) pointed to by the context index. At block 610, the encoder and/or decoder may entropy code (e.g., arithmetic code) the occupancy bit of the current child cuboid based on the context. Thus, the occupancy bit of the current child cuboid may be coded based on occupancy bits of the already-coded cuboids neighboring the current child cuboid.

Although not shown in FIG. 6, the encoder and/or decoder may further update the reduction function DRn into DRn+1 and update the context index LUT[β′] based on the occupancy bit of the current child cuboid. In addition, the method of FIG. 6 may be repeated for additional or all child cuboids of parent cuboids corresponding to nodes of the occupancy tree in a scan order, such as the scan order discussed above with respect to FIG. 3.

In general, the occupancy tree is a lossless compression technique. The occupancy tree may be adapted to provide lossy compression by modifying the point cloud on the encoder side (e.g., down-sampling, removing points, moving points, etc.) but the lossy compression performance may be reduced/weak. However, the use of the occupancy tree as a lossless compression technique may be very useful for dense point clouds.

One approach to lossy compression for point cloud geometry may be to set the maximum depth of the occupancy tree to not reach the smallest volume size of one voxel but instead to stop at a bigger volume size (e.g., N×N×N cubes, where N>1). The geometry of the points belonging to each occupied leaf node associated with the bigger volumes may then be modeled. This approach may be particularly suited for dense and smooth point clouds that may be locally modeled by smooth functions like planes or polynomials. The coding cost may become the cost of the occupancy tree plus the cost of the local model in each of the occupied leaf nodes.

A scheme for modeling the geometry of the points belonging to each occupied leaf node, associated with a volume size larger than one voxel, may use sets of triangles as local models. This scheme may be referred to as the “TriSoup” scheme. TriSoup is short for “Triangle Soup” because the connectivity between triangles may not be part of the models. An occupied leaf node, of an occupancy tree, that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate (a presence of or) whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may further comprise a position (pₖ) of the vertex (Vₖ) along the TriSoup edge.

In addition to the occupancy words of an occupancy tree, an encoder may entropy encode, for each TriSoup node of the occupancy tree, a TriSoup vertex presence flag (and a position of a TriSoup vertex, if present, along a TriSoup edge) of each TriSoup edge belonging to the TriSoup node. A decoder may similarly entropy decode the TriSoup vertex presence flags and positions of each TriSoup vertex along a respective TriSoup edge belonging to a TriSoup node of the occupancy tree, in addition to the occupancy words of the occupancy tree.

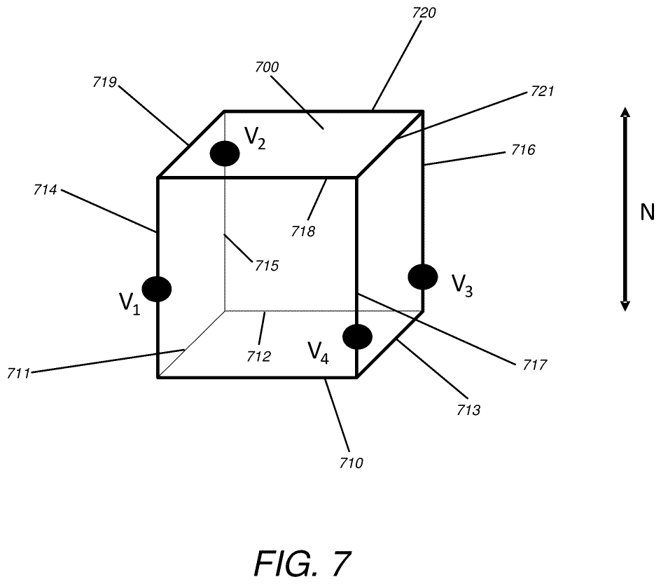

FIG. 7 illustrates an example of an occupied cube 700 of size N×N×N (where N>1) that corresponds to a TriSoup node of an occupancy tree. Occupied cube 700 comprises TriSoup edges 710-721. The TriSoup node, corresponding to occupied cube 700, comprises a presence flag (sₖ) for each TriSoup edge of TriSoup edges 710-721. The presence flag of TriSoup edge 714 indicates that a TriSoup vertex V₁ is present on TriSoup edge 714. The presence flag of TriSoup edge 715 indicates that a TriSoup vertex V₂ is present on TriSoup edge 715. The presence flag of TriSoup edge 716 indicates that a TriSoup vertex V₃ is present on TriSoup edge 716. The presence flag of TriSoup edge 717 indicates that a TriSoup vertex V₄ is present on TriSoup edge 718. The presence flags of the remaining TriSoup edges each indicates that a TriSoup vertex is not present on their corresponding TriSoup edge. The TriSoup node, corresponding to occupied cube 700, further comprises a position for each TriSoup Vertex present along one of its TriSoup edges 710-721. More specifically, the TriSoup node (corresponding to occupied cube 700) further comprises a position p₁ for TriSoup vertex V₁, a position p₂ for TriSoup vertex V₂, a position p₃ for TriSoup vertex V₃, and a position p₄ for TriSoup vertex V₄. The TriSoup vertices may be shared among TriSoup nodes along TriSoup edge(s) in common.

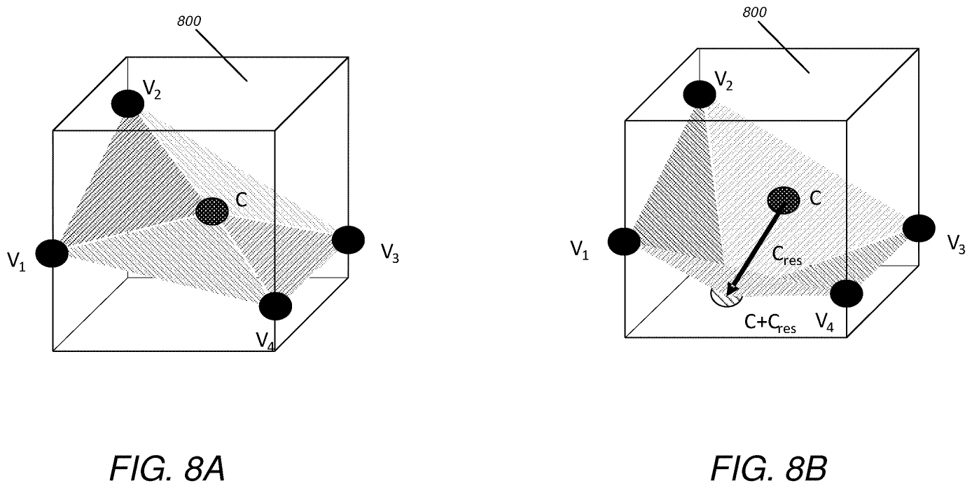

FIG. 8A illustrates a cube 800 corresponding to a TriSoup node with a number K of TriSoup vertices Vₖ. Within cube 800, TriSoup triangles may be constructed from the TriSoup vertices Vₖ if at least three (K≥3) TriSoup vertices are present on the TriSoup edges of cube 800. In the example of FIG. 8A, 4 TriSoup vertices are present and therefore TriSoup triangles are constructed. The TriSoup triangles may be constructed around the centroid vertex C defined as the mean of the TriSoup vertices Vₖ. In some examples, to construct the TriSoup triangles, a dominant direction may first be determined, then vertices Vₖ may be ordered by turning around this direction, and finally the following K TriSoup triangles are constructed: V₁V₂C, V₂V₃C, . . . , V_{K}V₁C. The dominant direction may be chosen among the three directions parallel to the axis of the 3D space to increase or maximize the 2D surface of the triangles when projected along the dominant direction. By doing so, the dominant direction may be somewhat perpendicular to a local surface defined by the points of the point cloud belonging to the TriSoup node.

FIG. 8B illustrates a refinement to the TriSoup model by coding a centroid residual value Cᵣₑₛ into the bitstream such as to use C+Cᵣₑₛ instead of C as a pivoting vertex for constructing/generating the triangles. By doing so, the vertex C+Cᵣₑₛ may be closer to the points of the point cloud than the centroid C used to model the points, which reduces the reconstruction error and leads to lower distortion at the cost of a small increase in bitrate needed for coding Cᵣₑₛ.

The reconstruction of a decoded point cloud from the set of TriSoup triangles may be referred to as “voxelization” and may be performed by ray tracing for each triangle individually before duplicated points between voxelized triangles are removed.

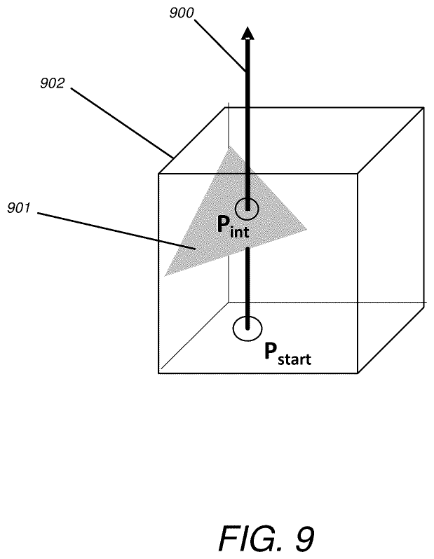

FIG. 9 illustrates an example of voxelization. As illustrated by FIG. 9, rays 900 may be launched parallel to one of the three axes of the 3D space, starting from integer coordinates Pₛₜₐᵣₜ. Their intersection Pᵢₙₜ (if any) with a TriSoup triangle 901 belonging to a cube 902, corresponding to a TriSoup node, may be rounded to determine a decoded point. This intersection may be found using the Möller-Trumbore algorithm, for example.

A presence flag (sₖ) and, if the presence flag (sₖ) indicates the presence of a vertex, a position (pₖ) (the presence flag (sₖ) and position (pₖ) individually or collectively referred to as vertex information) of the vertex along a current TriSoup edge may be entropy coded based on already-coded presence flags and positions (of present TriSoup vertices) of TriSoup edges that neighbor the current TriSoup edge. A presence flag (sₖ) and, if the presence flag (sₖ) indicates the presence of a vertex, a position (pₖ) on (e.g., indicating a position of the vertex along) a current TriSoup edge may be additionally or alternatively entropy coded based on occupancies of cuboids that neighbor the current TriSoup edge. Similar to the entropy coding of the occupancy bits of the occupancy tree, a configuration BTs for a neighborhood (also referred to as a neighborhood configuration β_{TS}) of a current TriSoup edge may be determined and dynamically reduced into a reduced configuration β_{TS}′=DRⁿ(β_{TS}) by using a dynamic OBUF scheme for TriSoup. A context index LUT [BTs′] may be determined from the OBUF LUT and at least a part of the vertex information of the current TriSoup edge may be entropy coded using the context (or probability model) pointed to by the context index.

In order to use a binary entropy coder to entropy code at least part of the vertex information of the current TriSoup edge, the TriSoup vertex position (pₖ) (if present) along its TriSoup edge may be binarized. A number of bits N_{b} may be set for the quantization of the TriSoup vertex position (pₖ) along the TriSoup edge of length N that is uniformly divided into 2^{Nb} quantization intervals. By doing so, the TriSoup vertex position (pₖ) may be represented by N_{b} bits (pₖ^{j}, j=1, . . . , N_{b}) that may be individually coded by the dynamic OBUF scheme as well as the bit corresponding to the presence flag (sₖ). The neighborhood configuration β_{TS}, the OBUF reduction function DRⁿ, and thus the context index may depend on the nature/characteristic/property of the coded bit (presence flag (sₖ), highest position bit (pₖ¹), second highest position bit (pₖ²), etc.). Therefore, there may be several dynamic OBUF schemes implemented, with each dedicated to a specific bit of information (presence flag (sₖ) or position bit (pₖ^{j}) of the vertex information.

In video compression, performance may be improved by using inter frame prediction. Bitrates needed to compress inter frames are typically one to two orders of magnitude lower than bitrates of intra frames that, by definition, do not use inter frame prediction. Point cloud data may behave differently because the 3D geometry is coded, unlike video coding where typically only the attributes (e.g., colors) are coded after projection of the 3D geometry onto a 2D plane (e.g., a camera sensor). Even if 2D-projected attributes are expected to temporally have a higher correlation than their underlying 3D geometry, it is nevertheless expected that inter frame prediction between 3D point clouds may provide improved compression capability than intra frame prediction alone within a point cloud. The octree may benefit from inter frame prediction and geometry compression gains.

The general framework of inter frame prediction for 3D point clouds is similar to the one of video compression.

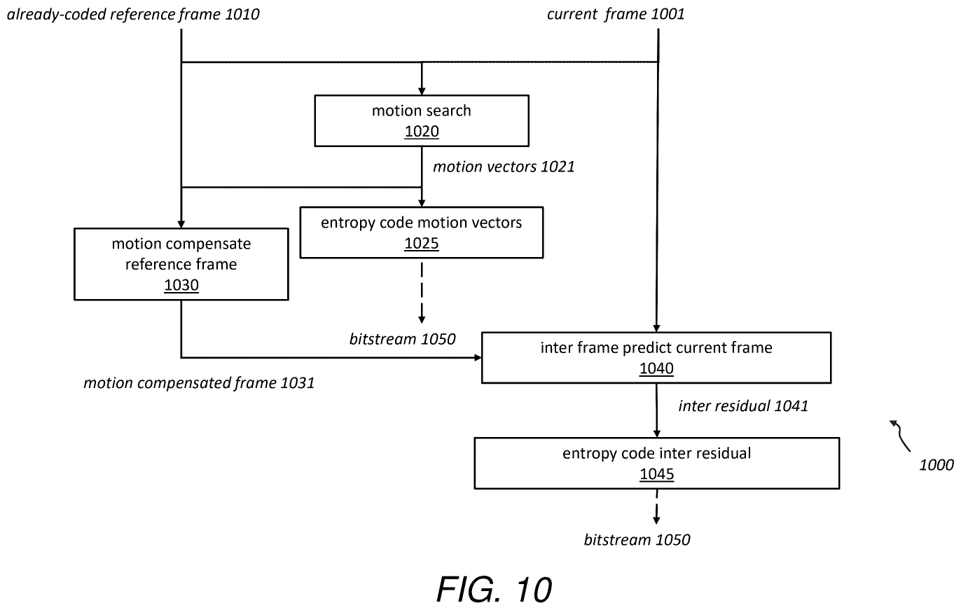

FIG. 10 illustrates a diagram 1000 of an example encoding method using inter frame prediction between point clouds. A current frame 1001 (e.g., an image or a point cloud) is coded relative to an already-coded reference frame 1010 (e.g., an image or a point cloud). A motion search 1020 is performed from the already-coded reference frame 1010 toward the current frame 1001 to determine motion vectors 1021 that represents a motion flow between the two frames 1010 and 1001. In video compression, motion vectors are 2-component (or 2D) vectors representing the motion from reference blocks of pixels to current blocks of pixels. In point cloud compression, motion vectors are 3-component (or 3D) vectors representing the motion from reference sets of 3D points (e.g., in a reference point cloud) to current sets of 3D points (e.g., in a current point cloud). Motion vectors 1021 are entropy coded 1025 into bitstream 1050. The reference frame 1010 is motion compensated 1030 to determine a motion compensated frame 1031. Motion compensation involves moving the pixels (respectively points) of the reference image (respectively point cloud) according to the 2D (respectively 3D) motion vectors. The determined motion compensated frame is “closer” to the current frame than the reference frame in the sense that the color difference (respectively point distance) between the motion compensated frame 1031 and the current frame 1001 is, on average, smaller than between the reference frame 1010 and the current frame 1001. At block 1040, inter frame prediction is performed to determine inter residuals 1041 that are entropy coded 1045 into bitstream 1050. The inter residuals may carry more compressible information than the current frame itself or the current frame that has undergone an intra prediction process. Therefore, the entropy coding 1045 may be more efficient such as to determine a bitstream 1050 with reduced size compared to a bitstream determined by coding the current frame 1001 that has not benefited from inter frame prediction.

In video coding, inter residuals are constructed as the difference of colors, pixel per pixel, between a current block of pixels belonging to the current frame (here image) and a co-located compensated block of pixels belonging to the motion compensated frame (here image). Inter residuals are then arrays of color differences that have typically small magnitude and thus may be efficiently compressed.

In point cloud compression, there is no such concept of the “difference” between two sets of points because there is not necessarily a one-to-one mapping of the two sets of points and the concept of an inter residual cannot be straightforwardly generalized to point clouds. For prediction of an octree representing a point cloud, the concept of inter residual may be replaced by conditional entropy coding where conditional information for performing conditional entropy coding is constructed based on a motion compensated point cloud. This may be extended to the framework of dynamic OBUF.

As described above, a current occupancy bit of an octree may be coded by an entropy coder selected by the output of a dynamic OBUF LUT of coder indices that takes a neighborhood configuration β as input. The neighborhood configuration β may be constructed based on already-coded occupancy bits associated with neighboring volumes relative to the current volume associated with the current node whose occupancy is signaled by the current occupancy bit. The construction of the neighborhood configuration β may be extended using inter frame information. An inter predictor occupancy bit may be defined for a current occupancy bit as a bit representative of the presence of at least one point of a motion compensated point cloud within the current volume. In the case that motion compensation is efficient, a strong correlation between the current occupancy bit and the inter predictor occupancy bit may exist because the current and motion compensated point clouds should be close to each other. Practically, using the inter predictor occupancy bit as a bit of the neighborhood configuration β may lead to better compression performance of the octree (e.g., dividing the size of the octree bitstream by a factor two).

In some examples, the motion field between octrees may comprise 3D motion vectors associated with 3D prediction units (PU) that have volumes that may include at least a part of one or several volumes (e.g., cuboids) associated with nodes of the octree. The motion compensation may be performed volume per volume (e.g., cuboid per cuboid) based on the 3D motion vectors to determine a motion compensated point cloud in one or more current volumes. The inter predictor occupancy bit may be determined based on the presence of at least one point of this motion compensated point cloud.

The TriSoup scheme may benefit from the motion compensated frame determined during the octree coding performed before the TriSoup coding. Predictors of the presence and position of TriSoup vertices may be determined based on the motion compensated point cloud. For example, these predictors may be determined based on the intersection of the compensated point cloud with the edges of the TriSoup nodes. Predictors of the centroid residual values may also be determined.

Therefore, the entropy coding of TriSoup vertices and centroid residual values may be performed by using these inter predictors. For example, inter predictors may constitute a part of a contextual information βᵢₙₜₑᵣ input of a dynamic OBUF instance that codes a TriSoup syntax element. In another example, a context may be selected based on inter predictors and the selected context may be used by an entropy coder (e.g., CABAC) to determine a probability used to arithmetically entropy code a TriSoup syntax element.

Attributes associated with points of a point cloud are typically coded after the coding of the underlying geometry (e.g., the positions of the points in the 3D space) has been performed. If the geometry coding is a lossless coding (e.g., by using an octree scheme), the encoder has direct access to the attribute values associated with the coded points. In some examples, if the geometry coding is a lossy coding (e.g., by using a TriSoup scheme), the coded geometry differs from the original geometry. In these examples, the original attributes may be mapped by the encoder from the original geometry to the coded geometry such as to determine mapped attributes on the coded geometry.

As explained above, attributes may indicate a property of a point's visual appearance such as, e.g., texture, color, material, transparency, reflectance, time stamp, velocity, etc. For attributes that are colors, this attribute mapping performed by the encoder is known as a recoloring process. This is because the colors of the original geometry are used to color (e.g., recolor) the coded geometry (e.g., a reconstructed geometry).

In some examples, the coded geometry and the mapped attributes for the coded geometry may comprise a coded point cloud representative of the original point cloud in both geometry and attributes. In some examples (e.g., used in G-PCC), there are two attribute coding schemes that may be used/selected for coding attributes associated with the coded geometry, namely the prediction with lifting transform (“pred-lift”) scheme and the region-adaptive hierarchical transform (“RAHT”) scheme.

In some examples, the pred-lift scheme first performs a decomposition of the coded geometry into Levels of Details (also known as LoD). For a set(S) of all points (e.g., points) of the coded geometry, the set is decomposed into disjoint subsets Sⁱ such that

$$S = {U}_{i = 0}^{L = 1} {S}^{i} .$$

By doing so, L levels of details are defined as a tower of point cloud geometries

$${S}^{0} ⊂ {S}^{0} ⋃ {S}^{1} ⊂ … ⊂ {S}^{0} ⋃ … ⋃ {S}^{L - 1} = S$$

where the set S⁰ of points is the first (e.g., coarsest) level of details, and the set S⁰∪ . . . ∪S^{L-1} of points is the Lth (e.g., finest) level of details.

Attributes aⱼ are associated with the points sⱼ of the set S of all points of the coded geometry. Considering subsets a⁰, . . . , a^{L-1} of attributes, attributes aⁱⱼ of a subset aⁱ are associated with the points sⁱⱼ of the subset Sⁱ. Therefore, the i^{th} level of details (S⁰∪ . . . ∪Sⁱ⁻¹) has associated attributes comprising the concatenation of attributes of subsets a⁰, . . . , aⁱ⁻¹. The set ‘a’ of all attributes may be partitioned into subsets a⁰, . . . , a^{L-1}.

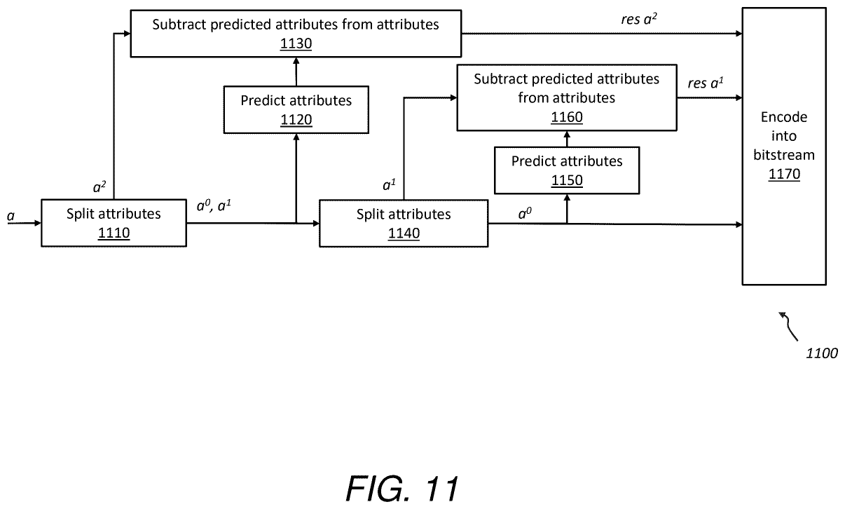

FIGS. 11-14 illustrate diagrams 1100-1400 of example processes for coding (e.g., encoding or decoding) point cloud attributes based on intra transform schemes such as a prediction transform scheme or a pred-lift scheme, according to some embodiments. The prediction transform scheme may be a variation of pred-lift scheme without update operations. These intra transform schemes are examples of wavelet transforms that converts (e.g., transforms) attribute values into wavelet coefficients that may be more efficiently compressed than the original attribute values. In some examples, these wavelet coefficients may represent values of residual attributes, which may be smaller and more efficiently compressed than the values of the original attributes. Therefore, the residual attributes may be referred to as and/or comprise wavelet coefficients (or alternatively transform/transformed coefficients) resulting from application of the prediction transform scheme.

As will be further described below, the prediction and pred-lift schemes generally operate using prediction for and between levels of details of attributes. In some examples, at the encoder, attributes at a higher (e.g., finer) level of detail may be predicted based on attributes at a lower (e.g., coarser) level of detail. For example, each level of detail starting from the highest level may be successively predicted based on lower level(s) of detail. The decoder may perform inverse operations such that attributes at a lower level of detail are predicted and reconstructed based on residual attributes of higher level(s) of detail. For example, each level of detail starting from the lowest level may be successively predicted and reconstructed based on higher level(s) of detail. Although the examples shown in FIGS. 11-14 show three levels of details (LoDs), it should be understood that the processes may be extended and iteratively performed for more LoDs.

FIG. 11 illustrates a diagram of an example process for encoding point cloud attributes based on a prediction transform scheme.

In this example, a set ‘a’ of attributes may be coded using prediction for and between three (L=3) levels of details, from a first level to a third level. At block 1110, an encoder may split a set ‘a’ of attributes into a first set of attributes comprising the attributes of the subset a² and a second set of attributes comprising the attributes of the two subsets a⁰ and a¹. At block 1120, the encoder may determine predictive values of the attributes of the first set of attributes (a²) from the attributes of the second set of attributes (a⁰ and a¹). At block 1130, the encoder may determine first residual values ‘res a²’ by subtracting the predictive values from the attributes of the first set of attributes (a²) and, at block 1170, the encoder may encode the first residual values ‘res a²’ into the bitstream.

In some examples, the operations at blocks 1120-1130 may be iteratively applied to each successively lower (e.g., coarser) LoD. For example, at block 1140, the encoder may split the second set of attributes (a⁰ and a¹) into third and fourth sets of attributes. The third set of attributes comprises the attributes of the subsets a¹ and the fourth set of attributes comprises the attributes of the subset a⁰. At block 1150, the encoder may determine predictive values of the attributes of the third set of attributes (a¹) from the attributes of the fourth set of attributes (a⁰). At block 1160, the encoder may determine second residual values ‘res a¹’ by subtracting predictive values from the attributes of the third set (a¹) and at block 1170, the encoder may encode the second residual values ‘res a¹’ into the bitstream and may encode the attributes of the fourth set of attributes (a⁰) into the bitstream.

Consequently, the bitstream may comprise data representative of first residual values ‘res a²’, second residual values ‘res a¹’ and the attributes of the subset a⁰ (fourth set of attributes). For example, the residual values may be entropy coded in block 1170.

In some examples, the encoder may directly encode the attributes of the subset a⁰ into the bitstream.

In some examples, the encoder may perform intra prediction of a current attribute a⁰ⱼ of the subset a⁰ to be coded based on already-coded attributes of the subset a⁰ to improve the compression efficiency of the attributes of the subset a⁰.

In some examples, the encoder may quantize the attributes of the subset a⁰, the first residual value ‘res a²’, and/or the second residual value ‘res a¹’ when lossy attribute coding is allowed.

In some examples, the encoder may entropy encode into the bitstream the attributes of the subset a⁰ or the quantized attributes of the subset a⁰, the first residual value ‘res a²’ or the quantized first residual values ‘res a²’, and/or the second residual value ‘res a¹’ or the quantized second residual value ‘res a¹’.

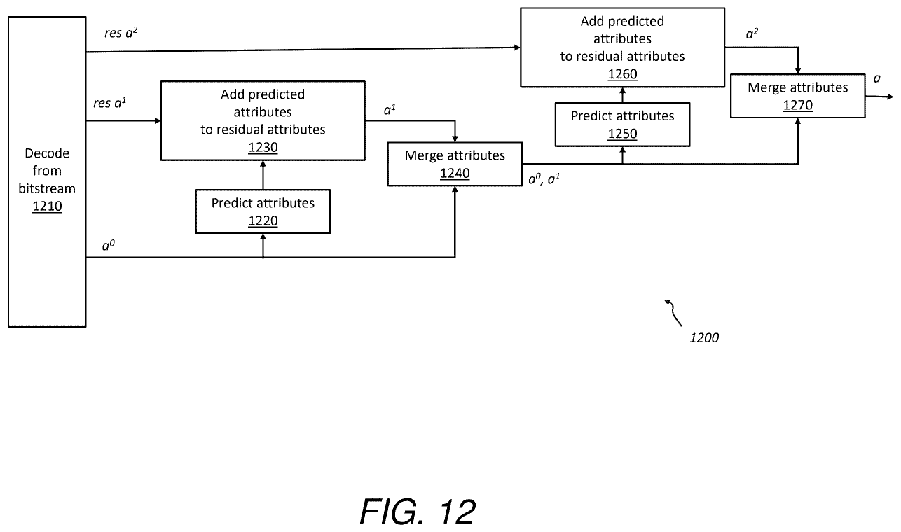

FIG. 12 illustrates a diagram 1200 of an example process for decoding point cloud attributes based on a prediction transform scheme.

In this example, a set ‘a’ of attributes encoded with the encoding of FIG. 11 is decoded using prediction between three (L=3) levels of details, from a first level to a third level. At block 1210, the decoder may decode the first residual values ‘res a²’, the second residual values ‘res a¹’ and attributes of a fourth set of attributes (a⁰) from the bitstream and may apply dequantization (e.g., in case of lossy compression). At block 1220, similar to block 1150, the decoder may determine predictive values of the attributes of a third set of attributes (a¹) from the decoded attributes of the fourth set of attributes (a⁰). At block 1230, the decoder may determine decoded attributes of the third set of attributes (a¹) by adding the predictive values to the decoded first residual values ‘res a¹’.

In some examples, the operations at blocks 1120-1230 may be iteratively applied to each successively higher (e.g., finer) LoD. For example, at block 1240, inverse of block 1140, the decoder may determine a second set of attributes (a⁰ and a¹) by merging the third set of attributes (a¹) and the fourth set of attributes (a⁰). At block 1250, similar to block 1120, the decoder may determine predictive values of the attributes of a first set of attributes (a²) from the attributes of the second set of attributes (a⁰ and a¹). At block 1260, the decoder may determine decoded attributes of the first set of attributes (a²) by adding the predictive values to the decoded second residual values ‘res a²’. At block 1270, inverse of block 1110, the decoder may determine the set ‘a’ of decoded attributes for the whole coded geometry S by merging the first set of attributes (a²) and the second set of attributes (a⁰ and a¹).

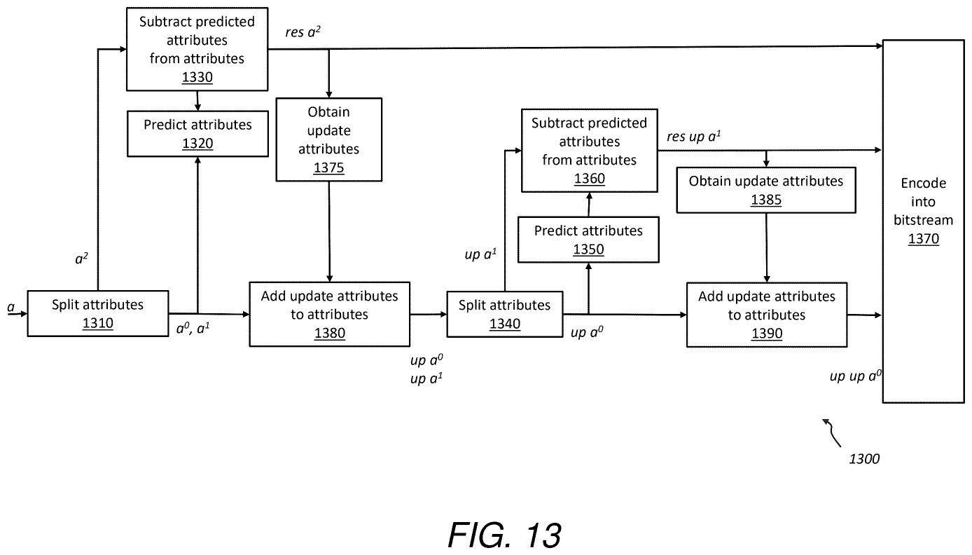

FIG. 13 illustrates a diagram 1300 of an example process for encoding point cloud attributes based on a pred-lift transform scheme with prediction and update.

In this example, a set ‘a’ of attributes is encoded using prediction between three (L=3) levels of details, from a first level to a third level. At block 1310, similar to block 1110, an encoder may split a set ‘a’ of attributes into a first set of attributes comprising the attributes of the subset a² and a second set of attributes comprising the attributes of the two subsets a⁰ and a¹. At block 1320, similar to block 1120, the encoder may determine predictive values of the attributes of the first set of attributes (a²) from the attributes of the second set of attributes (a⁰ and a¹). At block 1330, similar to block 1130, the encoder may determine first residual values ‘res a²’ by subtracting predictive values from the attributes of the first set of attributes (a²) and at block 1370, similar to block 1170, the encoder may encode the first residual values ‘res a²’ into the bitstream.

At block 1375, the encoder may determine update attribute values from the first residual values ‘res a²’. For example, the encoder may determine an update attribute value based on a first residual value. For example, the update attribute value may be determined as the first residual value multiplied by a scaling factor (e.g., ½, ¼, ⅛, etc.) that may be predetermined or signaled in the bitstream. At block 1380, the encoder may update attribute values ‘up a⁰’ and ‘up a¹’ of the second set of attributes (a⁰ and a¹) by adding the update attribute values to the attribute values of the second set of attributes (a⁰ and a¹).

In some examples, the operations at blocks 1320, 1330, 1375, and 1380 may be iteratively applied to each successively lower (e.g., coarser) LoD. For example, at block 1340, the encoder may split the second set of attributes (a⁰ and a¹) into a third and fourth set of attributes. The third set of attributes comprises the updated attribute values ‘up a¹’ of the subset a¹ and the fourth set of attributes comprises the updated attribute values ‘up a⁰’ of the subset a⁰. At block 1350, the encoder may determine predictive values of the updated attribute values ‘up a¹’ of the third set of attributes (a¹) from the updated attribute values ‘up a⁰’ of the fourth set of attributes (a⁰). At block 1360, the encoder may determine third residual values ‘res up a¹’ by subtracting predictive values from the updated attribute values ‘up a¹’ of the third set of attributes (a¹) and at block 1370, the encoder may encode the third residual values ‘res up a¹’ into the bitstream. At block 1385, the encoder may determine update attribute values from the third residual values ‘res up a¹’. At block 1390, the encoder may determine further updated attribute values ‘up up a⁰’ of the fourth set of attributes (a⁰) by adding the update attribute values to the updated attribute values ‘up a⁰’ of the fourth set of attributes (a⁰). At block 1370, the encoder may encode the further updated attribute values ‘up up a⁰’ of the fourth set of attributes (a⁰) into the bitstream.

Consequently, the bitstream may comprise data representative of transformed attributes i.e. data representative of the first residual values ‘res a²’, third residual values ‘res up a¹’ and further updated attribute values ‘up up a⁰’ of the fourth set of attributes.

In some examples, the encoder may directly encode the further updated attribute values ‘up up a⁰’ of the fourth set of attributes into the bitstream.

In some examples, the encoder may perform intra prediction of a current further updated attribute values ‘up up a⁰ⱼ’ to be coded based on already-coded attributes of the fourth set of attributes to improve the compression efficiency of the further updated attribute values ‘up up a⁰’ of the fourth set of attributes.

In some examples, the encoder may quantize the further updated attribute values ‘up up a⁰’ of the fourth set of attributes, the first residual value ‘res a²’ and/or the third residual value ‘res up a¹’ when lossy attribute coding is allowed.

In some examples, the encoder may entropy encode into the bitstream the further updated attribute values ‘up up a⁰’ of the fourth set of attributes, the first residual value ‘res a²’ or the quantized first residual values ‘res a²’, and/or the third residual value ‘res up a¹’ or the quantized third residual value ‘res up a¹’.

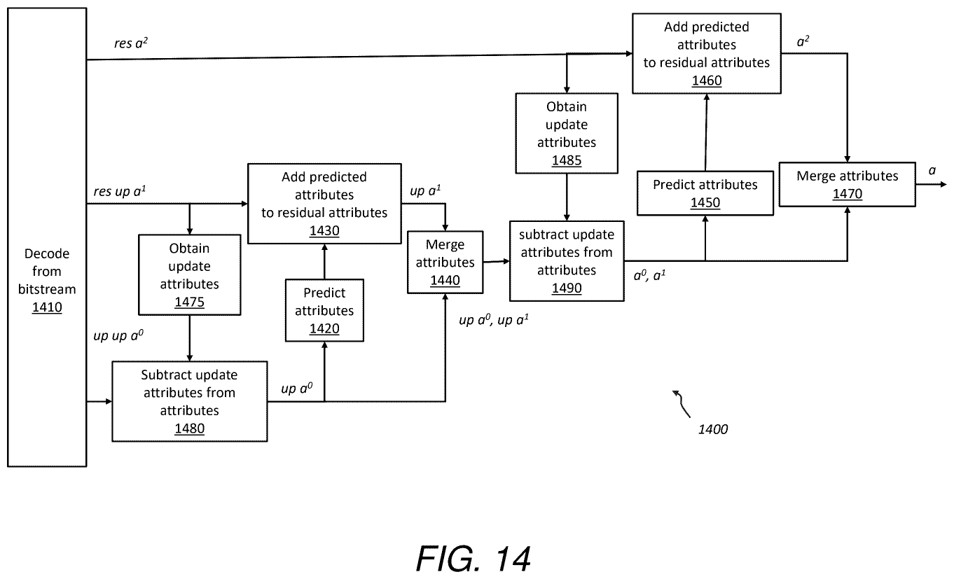

FIG. 14 illustrates a diagram of an example process for decoding point cloud attributes based on a pred-lift transform scheme with prediction and update.

In this example, a set ‘a’ of attributes encoded with the encoding of FIG. 13 is decoded using prediction between three (L=3) levels of details, from a first level to a third level.

At block 1410, the decoder may decode the first residual values ‘res a²’, the third residual values ‘res up a¹’ and further updated attribute values ‘up up a⁰’ of a fourth set of attributes (a⁰) from the bitstream and may apply an optional dequantization in case of lossy compression. At block 1475, similar to block 1385, the decoder may determine update attribute values from the decoded third residual values ‘res up a¹’. For example, the decoder may determine an update attribute value based on the third residual values. For example, the update attribute value may be determined as the third residual values multiplied by a scaling factor (e.g., ½, ¼, ⅛, etc.) that may be predetermined or signaled in the bitstream.

At block 1480, the decoder may determine updated attribute values ‘up a⁰’ of the fourth set of attributes (a⁰) by subtracting the update attribute values from the decoded further updated attribute values ‘up up a⁰’ of the fourth set of attributes (a⁰). At block 1420, similar to block 1350, the decoder may determine predictive values of the updated attribute values ‘up a¹’ of a third set of attributes (a¹) from the updated attribute values ‘up a⁰’ of the fourth set of attributes (a⁰). At block 1430, the decoder may determine updated attribute values ‘up a¹’ of the third set of attributes (a¹) by adding the predictive values to the decoded third residual values ‘res up a¹’. At block 1440, inverse of block 1340, the decoder may determine a second set of attributes (a⁰ and a¹) by merging the third set of attributes (a¹) and the fourth set of attributes (a⁰). The second set of attributes (a⁰ and a¹) comprises updated attribute values ‘up a⁰’ and updated attribute values ‘up a¹’. At block 1485, similar to block 1375, the decoder may determine update attribute values from the decoded first residual values ‘res a²’.

In some examples, the operations at blocks 1420, 1430, 1440, 1475, and 1480 may be iteratively applied to each successively higher (e.g., finer) LoD. For example, at block 1490, the decoder may determine attribute values ‘a⁰’ and attribute values ‘a¹’ of the second set of attributes (a⁰ and a¹) by subtracting the update attribute values from the updated attribute values ‘up a⁰’ and from updated attribute values ‘up a¹’ of the second set of attributes (a⁰ and a¹). At block 1450, similar to block 1320, the decoder may determine predictive values of the attributes of a first set of attributes (a²) from the attributes of the second set of attributes (a⁰ and a¹). At block 1460, the decoder may determine decoded attributes of the first set of attributes (a²) by adding the predictive values to the decoded second residual values ‘res a²’. At block 1470, inverse of block 1310, the decoder may determine the set ‘a’ of decoded attributes for the whole coded geometry S by merging the first set of attributes (a²) and the second set of attributes (a⁰ and a¹).

In some examples, pred-lift schemes may be similar to the well-known so-called lifting scheme applied to wavelets in image coding. Adding update steps, as in the pred-lift scheme, may provide better compression performance in combination with the prediction steps.

In some examples, instead of using the pred-lift scheme, attributes may be coded using the RAHT scheme that is based on the iterative use of a two-point transform. In the framework of point cloud attribute coding, the two-point RAHT transform is to be understood as being applied to two sets A₁ and A₂ of attributes having respectively w₁ and w₂ number of attributes and respective associated coefficients c_{A1} and c_{A2} representative of the sum of attribute values over their respective set divided by the square root of the number of attributes.

$${c}_{Ai} = \frac{1}{\sqrt{{w}_{i}}} {\sum }_{a ∈ {A}_{i}} a . ( {w}_{i} = \# {A}_{i} ) \qquad \text{(*} )$$

The two-point RAHT transform depends on the weights w₁ and w₂ and is defined by a 2×2 matrix as follows

$$RAHT ( {w}_{1} , {w}_{2} ) = \frac{1}{\sqrt{{w}_{1} + {w}_{2}}} [ \begin{matrix}\sqrt{{w}_{1}} & \sqrt{{w}_{2}} \\ - \sqrt{{w}_{2}} & \sqrt{{w}_{1}}\end{matrix} ] .$$

When applied to the two coefficients c_{A1} and c_{A2}, two new coefficients DC and AC are determined.

$$[ \begin{matrix}DC \\ AC\end{matrix} ] = RAHT ( {w}_{1} , {w}_{2} ) [ \begin{matrix}{c}_{A 1} \\ {c}_{A 2}\end{matrix} ]$$

As illustrated below, the above property (*) on coefficients still holds for the DC coefficient.

$$DC = \frac{1}{\sqrt{{w}_{1} + {w}_{2}}} ( \sqrt{{w}_{1}} {c}_{A 1} + \sqrt{{w}_{2}} {c}_{A 2} ) = \frac{1}{\sqrt{{w}_{1} + {w}_{2}}} ( {\sum }_{a ∈ {A}_{1}} a + {\sum }_{a ∈ {A}_{2}} a ) = \frac{1}{\sqrt{{w}_{1} + {w}_{2}}} {\sum }_{a ∈ {A}_{1} ⋃ {A}_{2}} a = {c}_{A 1 ⋃ A2}$$

The two point RAHT transform may be applied iteratively to DC coefficients. This is the RAHT iterative method. Once determined, AC coefficients do not undergo any further transformation. At the start of the RAHT iterative method, there are as many initial sets Aᵢ of attributes as there are points in the coded geometry S. Each initial set Aᵢ of attributes thus contains one attribute (wᵢ=1) and the coefficient c_{Ai} is equal to the value of this one attribute, thus fulfilling the property (*). By induction, the property (*) holds for all subsequent DC coefficients determined after iterative application of the two point RAHT transform.

Therefore, at any stage of the RAHT iterative method, determined coefficients are the union of a set of DC coefficients fulfilling the property (*) and a set of AC coefficients. The RAHT iterative method may continue until DC coefficients are depleted and only one DC coefficient is left. In this case, this one DC coefficient is equal to CA where A is the set of all attributes associated with the complete coded geometry S. The RAHT iterative method may a priori follow any order among pairs of DC coefficients.

The two-point inverse RAHT transform may be defined by a 2×2 matrix as follows

$$iRAHT ( {w}_{1} , {w}_{2} ) = \frac{1}{\sqrt{{w}_{1} + {w}_{2}}} [ \begin{matrix}\sqrt{{w}_{1}} & - \sqrt{{w}_{2}} \\ \sqrt{{w}_{2}} & \sqrt{{w}_{1}}\end{matrix} ]$$

and is applied to DC and AC coefficients such as to obtain back the two coefficients c_{A1} and c_{A2}.

$$[ \begin{matrix}{c}_{A 1} \\ {c}_{A 2}\end{matrix} ] = iRAHT ( {w}_{1} , {w}_{2} ) [ \begin{matrix}DC \\ AC\end{matrix} ]$$

The inverse iterative RAHT method applies the inverse two-point RAHT to DC and AC coefficient in reverse order relative to their obtention by the iterative RAHT method. At the end of the inverse iterative RAHT method, coefficients c_{Ai} associated with the initial sets Aᵢ of attributes are obtained. These coefficients c_{Ai} are equal to the values of the one attributes associated with the initial sets Aᵢ.

In some examples, for lossy RAHT compression of attributes, coefficients are further compressed based on applying a quantization step to the DC and AC coefficients before encoding in the bitstream. The decoder applies a dequantization after decoding of the quantized DC and AC coefficients from the bitstream.

In some examples (e.g., such as in G-PCC), the RAHT iterative method follows an octree as a specific iterative order. Basically, the up to eight DC coefficients associated with the up to eight occupied child nodes of a parent node in the octree undergo a cascade of two-point RAHT transformations until one DC coefficient remains, together with up to seven AC coefficients. This one DC coefficient is pushed at parent node level and the method is repeated at upper octree depth until the root node is reached.

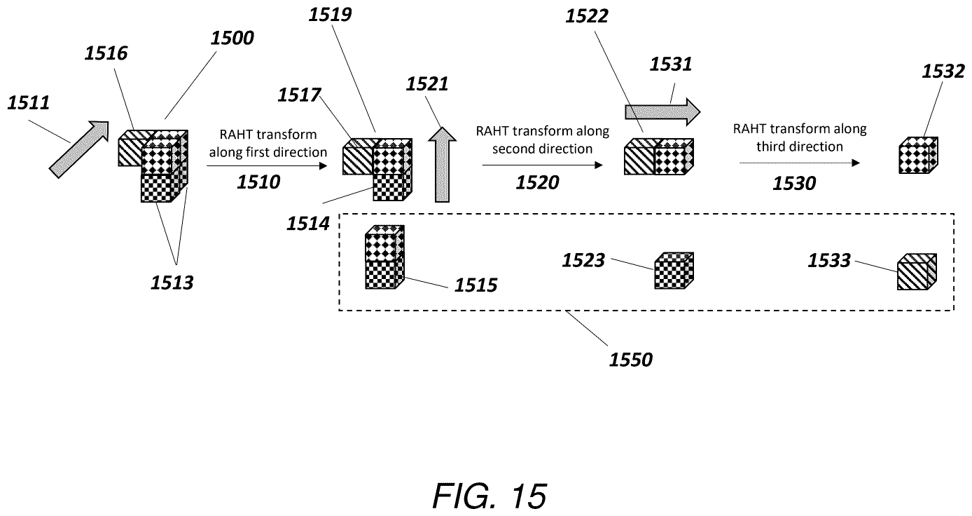

FIG. 15 illustrates an example RAHT transformation applied on child nodes of an octree parent node along three successive directions.

The parent node 1500 has five occupied child nodes with associated coefficients ci and weights wᵢ. A first RAHT transformation 1510 is performed along a first direction 1511. If there are two adjacent occupied child nodes 1513 along this direction, they undergo a two-point RAHT transform to determine a new DC coefficient 1514 and an AC coefficient 1515 pushed to a set 1550 of AC coefficients. If there is only one occupied child node 1516 along this direction, the node is left as is and its DC coefficient is kept 1517. By doing so, the child nodes are collapsed along the first direction to determine a new set 1519 of nodes, here a set of three nodes, with associated new DC coefficients. Then, a second RAHT transformation 1520 is performed along a second direction 1521 in a similar way to determine child nodes 1522, that have been collapsed along the first two directions 1511 and 1521, together with AC coefficients 1523 pushed to the set 1550 of AC coefficients. Finally, a third RAHT transformation 1530 is performed along a third direction 1531 in a similar way to determine a unique child node 1532, resulting from the collapse along all three directions, together with AC coefficients 1533 pushed to the set 1550 of AC coefficients.

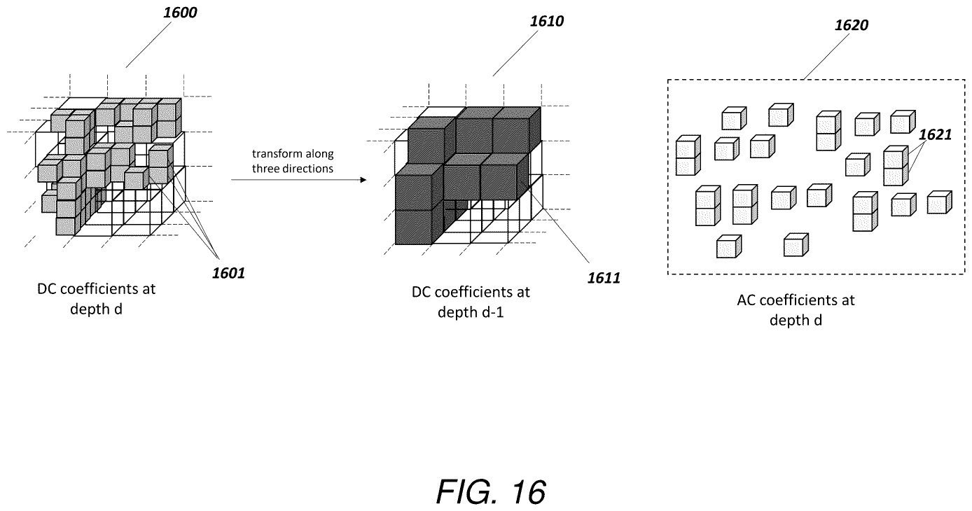

The unique collapsed child node 1532 has an associated DC coefficient that is pushed to the parent node as illustrated in FIG. 16.

FIG. 16 illustrates an example RAHT transformation being applied to all octree nodes at depth ‘d’ to determine DC coefficients at depth d−1 and AC coefficients. Occupied nodes 1600 of an octree at depth d are illustrated. These nodes undergo a RAHT transformation along the three directions such as to push DC coefficients up to their occupied parent nodes 1610 belonging to the octree at depth d−1. For example, the three DC coefficients of the child nodes 1601 undergo a RAHT transformation along the three directions to determine a unique DC coefficient associated with their parent node 1611 and two AC coefficients 1621 pushed to a set 1620 of AC coefficients. By performing this method for all occupied nodes 1600 of the octree at depth d, the DC coefficients associated with occupied nodes of the octree at depth d are transformed into DC coefficients associated with occupied nodes 1610 of the octree at depth d−1 and a set 1620 of AC coefficients.

This bottom-up method may be repeated depth per depth until reaching the minimum depth (the root node) and the result of the RAHT transformation over the complete octree is a set of coefficients comprising a unique DC coefficient and a set of (many) AC coefficients.

The RAHT transformation method typically starts from the highest depth where occupied child nodes correspond to a unique point (voxel) of the coded point cloud S associated with a unique attribute among the set ‘a’ of attributes. The DC coefficient at highest depth is thus set as the value of the unique attribute associated with each occupied node and the weights ‘w’ are set to 1.

The inverse RAHT method on an octree is a top-down method from the root node down to the last depth made of leaf nodes that contain each only one point of the point cloud, thus only one associated attribute. The DC coefficients of occupied nodes 1610 of the octree at depth d−1 are inverse transformed into DC coefficients of occupied nodes 1600 of the octree at depth d by applying the inverse two-point RAHT transform to the DC coefficient of each of the occupied node of the octree at depth d−1 and to the related AC coefficients from set 1620 of AC coefficients. The inverse two-point RAHT transform is applied along the three directions, in reverse order, such as to invert the node transformation process of FIG. 15. By doing so, DC coefficients of the leaf nodes are obtained, and their values correspond to the attributes associated with the unique point of each of the leaf nodes. Like geometry coding of a point cloud, coding of attributes associated with the points of a current point cloud may benefit from inter frame prediction using a motion compensated point cloud. The motion compensated point cloud inherits naturally attributes from a reference point cloud that has been motion compensated: during motion, points keep their associated attributes. The motion compensated attributes, i.e. the attributes associated with the points of the motion compensated point cloud, may be used to better compress the attributes of the coded geometry of the current point cloud.

Inter pred-lift scheme may use motion compensated attributes (or, in some embodiments to further increase compression, residual attributes based on differences between attributes and motion-compensated attributes) which are easily used in the pred-lift scheme by plugging them to the prediction blocks 1120, 1150, 1220, 1250, 1320, 1350, 1420 and 1450. For example, attributes (or residual attributes) aⁱ of the set Sⁱ of points may be predicted not only by attributes (or residual attributes) of the subsets a⁰, . . . , aⁱ⁻¹ of the lower level of details S⁰∪ . . . ∪Sⁱ⁻¹, but also by motion compensated attributes (or residual attributes) of a set a^{inter} associated with points of a motion compensated point cloud S^{inter}. Practically, the prediction step may be performed based on attributes (or residual attributes) of subsets a⁰, . . . , aⁱ⁻¹ and of a set a^{inter} of an augmented lower level of details S⁰∪ . . . ∪Sⁱ⁻¹∪S^{sinter}.

Consequently, the encoder and/or decoder may determine predictive values of the attributes (or residual attributes) of the fourth set of attributes (or residual attributes) (subset a⁰ of the coarsest level of details S⁰) from the motion compensated attributes (or residual attributes) of the set a^{inter} associated with the points of a motion compensated point cloud Sinter, and the encoder and/or decoder may subtract the predictive values from the attributes (or residual attributes) of the fourth set of attributes (or residual attributes) to determine residual values ‘res a⁰’. The encoder may encode the residual values ‘res a⁰’ (or residual of residual attributes) into the bitstream instead of the attributes (or residual attributes) of the fourth set of attributes.

Inter RAHT scheme uses inter prediction for predicting the values of the DC and the AC coefficients determined by the RAHT iterative method. Because the generation of DC and AC coefficients follows an octree, it is essential to maintain, as much as possible, a common attribute octree structure for both a current point cloud S^{coded} to be coded and a motion compensated point cloud S^{inter}. A common bounding box encompassing both point clouds may be determined, and an octree partitioning may be performed, from a root node associated with the common bounding box, for both point clouds. This leads to two octree partitioning that are different when the point clouds are not equal, which is likely. The two octrees have a common subtree starting from the root node. On this subtree, occupied node topology is the same and a common set of DC and AC coefficients is determined for both point clouds. Thus, the subset of DC and AC coefficients associated with nodes of the common subtree and determined from the attributes of the current point cloud S^{coded} may be predicted from DC and AC coefficients determined from the attributes of the motion compensated point cloud S^{inter}. Practically, the encoder and/or decoder may determine coefficient residual values by subtracting the DC and AC coefficients determined from the attributes of the motion compensated point cloud S^{inter} from the DC and AC coefficients associated with nodes of the common subtree and determined from the attributes of the current point cloud S^{coded}. The encoder may encode the coefficient residual values into the bitstream instead of the DC and AC coefficients associated with nodes of the common subtree and determined from the attributes of the current point cloud S^{coded}.

The DC and AC coefficients that are not associated with nodes of the common subtree may not be predicted and may be coded directly in a similar way as performed for the case without inter prediction.

Alternatively, instead of predicting AC coefficients, predicted DC coefficients of the current point cloud S^{coded} may be determined at some depth, assuming both the octree of the current point cloud S^{coded} and the octree of the motion compensated point cloud S^{inter} have a same occupancy of a node at this depth. The predicted DC coefficients may be determined from their co-located DC coefficients of the motion compensated point cloud S^{inter}. DC residual values may be determined by subtracting the predicted DC coefficients from the DC coefficients of the current point cloud S^{coded}. The RAHT transformation then goes up in the octree starting from DC residual values replacing the DC coefficients of the coded current point cloud.

A RAHT scheme process that does not use information from a reference frame different from the current frame is called an intra RAHT scheme. Intra prediction may be performed between DC and AC coefficients of an intra RAHT scheme. For example, so-called inter-depth prediction within a current frame has been integrated into the RAHT scheme of GPCC. The inter-depth prediction mechanism predicts the DC coefficients associated with nodes of the octree at depth d by using interpolation of DC coefficients associated with nodes of the octree at lower depth d−1.

The compression performance is important for the success of a codec, but its implementability is another essential factor. During the development and standardization of codecs, complexity, latency, throughput, memory traffic and footprint are factors that are considered when architecting the codec and adding tools.

Concerning the coding of dense point clouds such as by G-PCC, used mainly for AR/VR applications, the implementation of the TriSoup-based geometry coder has been rearchitected such as to perform operations that are mostly spatially local, thus reducing the latency before outputting decoded points as well as reducing memory traffic and memory footprint.

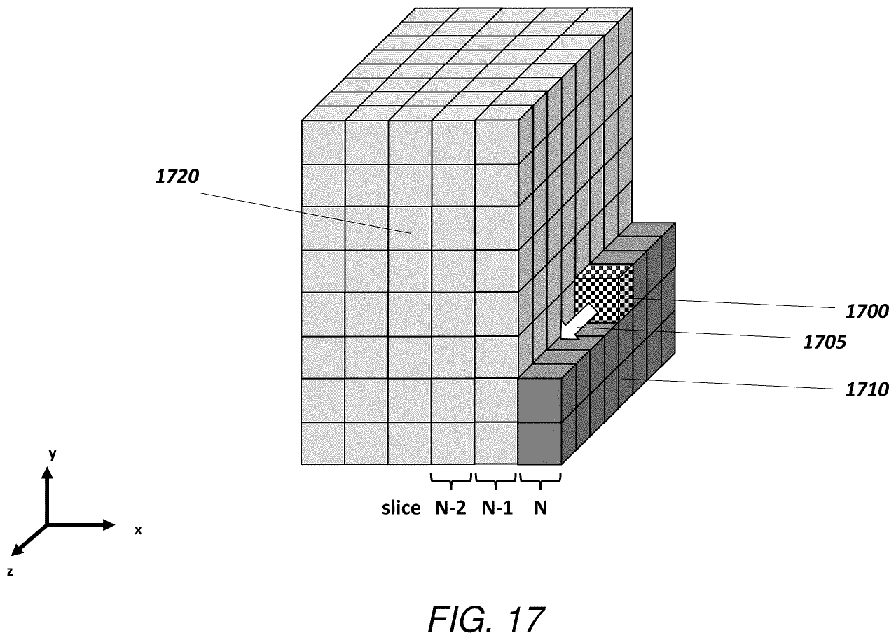

In existing implementations of point cloud codecs, the scanning order of the underlying octree has been modified from a Morton order to a raster scan order as depicted in FIG. 17. The raster scan order of nodes is a lexicographic order in x, then y, and then z directions. The octree is processed in a breadth-first order, depth per depth. The occupied leaf nodes of the last depth correspond to the TriSoup nodes. Nodes of each depth are scanned following the raster scan order. Nodes are grouped into slices corresponding to a same x coordinate. For example, the N-th slice (or slice N) contains all nodes having a same x coordinate for their start position; this same x coordinate is the N-th x coordinate among Nₓ coordinates of start position of nodes. Consequently, for a bounding box (e.g., a box encompassing the point cloud) with width Wₓ along the x axis and the node size along x being Sₓ for a current depth, there are Nₓ=Wₓ/Sₓ slices of nodes for the current depth. As a consequence of the raster scan order and neighbor prediction between nodes, nodes are coded one slice after the other by the octree process.

FIG. 17 illustrates a raster scan order along a slice of a point cloud frame. A current node 1700 (e.g., shown with checkboard pattern) is being coded following a raster scan order symbolized by the white arrow 1705. The current node belongs to slice N of nodes for which some nodes 1710 (e.g., shown in dark gray) have their occupancies already been coded. Nodes 1720 (e.g., shown in light gray) of preceding slices N−1, N−2, etc., have also their occupancies already been coded. Not all nodes of the octree are occupied.

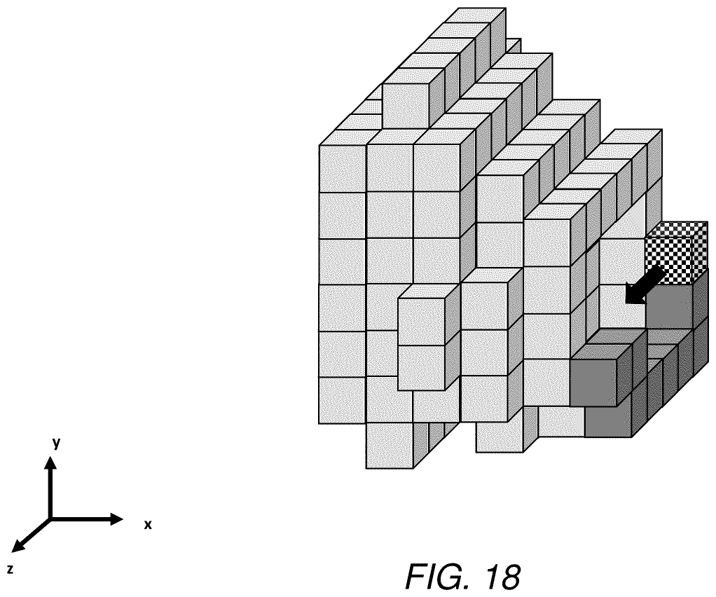

FIG. 18 illustrates an example octree at the last depth with only occupied nodes being shown. These occupied leaf nodes correspond to TriSoup nodes within which the point cloud frame will be modeled by sets of triangles. Local processing of the geometry coding is obtained by imposing the same raster scan coding order to TriSoup nodes such that occupied leaf nodes of the underlying octree are processed by the TriSoup coder with the shortest latency possible. By doing so, the geometry of decoded points can be output slice per slice during the decoding process and the latency is reduced.

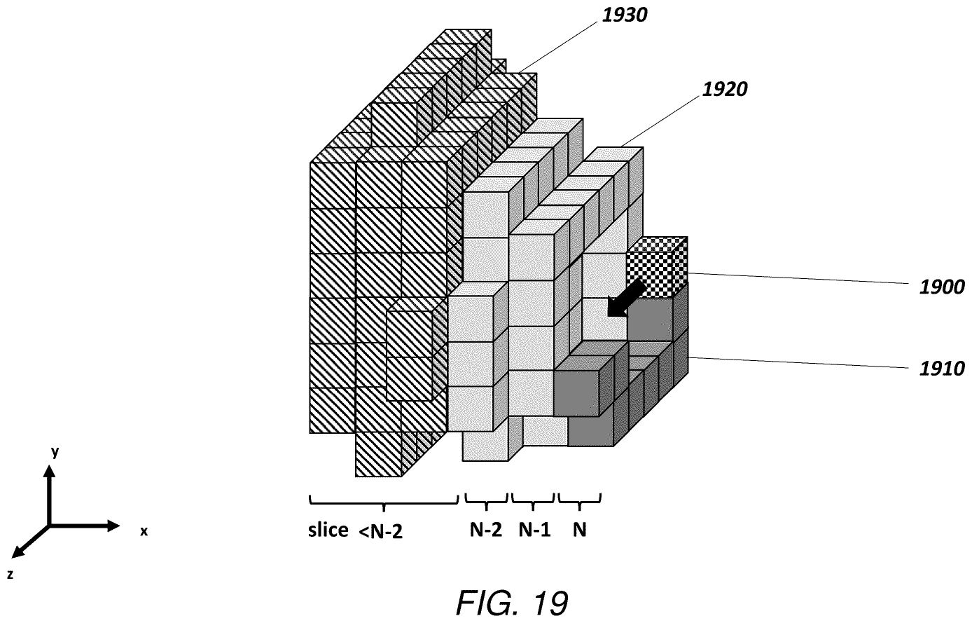

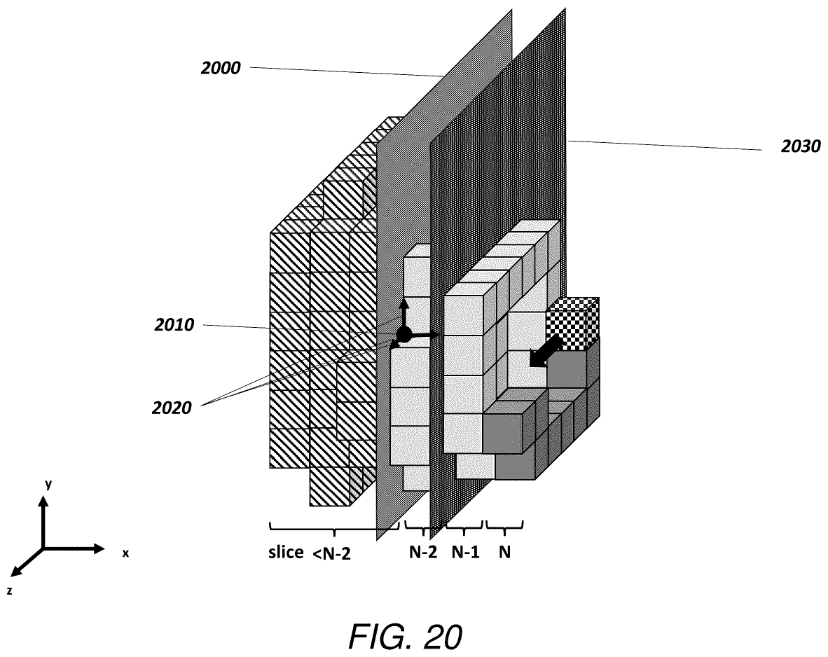

The memory traffic and memory footprint are also greatly reduced thanks to the local processing within a few slices as explained with the support of FIG. 19 and FIG. 20.

FIG. 19 illustrates an example octree at the last depth with only occupied nodes being shown.

The current occupied leaf node 1900 (e.g., shown with checkboard pattern) is being coded and belongs to slice N of nodes for which some leaf nodes 1910 (e.g., shown with dark gray) have been already processed by the octree coder and are occupied. Slice N is thus being processed by the octree coder. Nodes 1920 (e.g. shown with light gray) of slices N−1 and N−2 have already been processed by the octree coder but not yet by the TriSoup coder. Nodes 1930 (e.g. shown with black diagonal stripes) of slices before slice N−2 have already been processed by both the octree coder and the TriSoup coder such that the geometry of points belonging to these slices has been entirely coded.

The two-slice delay between octree coding and TriSoup coding is due to the coding of TriSoup vertices belonging to edges of the TriSoup nodes. The coding of TriSoup vertices of a current edge is performed by a dynamic OBUF process that takes as input a neighborhood contextual information made of already coded edges and of the occupancies of leaf nodes neighboring the current edge. Because the occupancies of the neighboring leaf nodes must be known before coding the TriSoup vertex, the TriSoup coding based on TriSoup vertices cannot be performed sooner than two slices behind relative to the octree coding that provides this neighboring information.

FIG. 20. illustrates an example octree at the last depth with only occupied nodes being shown.

Slice N is being coded by the octree process. TriSoup vertices belonging to edges 2020 whose start point 2010 is located on the plane 2000 between slice N−3 and slice N−2 have already been coded because the neighborhood contextual information used for their coding is known. In particular, the coding of TriSoup vertices belonging to edges parallel to the x axis requires the knowledge of the occupancies of octree leaf nodes of slice N−1. Therefore, some TriSoup vertices belonging to edges whose start point is located on the plane 2030 between slice N−2 and slice N−1 cannot be coded yet due to the lack of occupancy information of octree leaf nodes of slice N. Consequently, nodes of slice N−2 cannot be entirely processed yet by the TriSoup coder. TriSoup nodes belonging to slices before slice N−2 have all TriSoup vertices being coded and the modeling by triangles can thus be performed.

Consequently, the memory traffic and footprint of the geometry coder based on octree and TriSoup schemes is limited to a few slices. The geometry coding process is local in the sense that information between nodes is exchanged within a domain of a few slices. Furthermore, geometry coding latency is low because it takes only the time of processing a few slices between the start of the coding of an octree leaf node and the complete coding, by the TriSoup process, of the points belonging to this node.

In existing technologies, point cloud attribute coders (e.g., G-PCC coders) code attributes using schemes such as pred-lift transform/scheme or the RAHT scheme. Contrary to geometry coders, these attribute coders perform non-local processes because the attribute coding schemes such as pred-lift and the RAHT schemes are not performed locally. Therefore, a first pass of complete geometry coding may need to be performed before performing a second pass of attribute coding on the whole coded geometry. This two-pass coding reduces the advantages that the geometry coding provides in terms of latency and memory footprint.

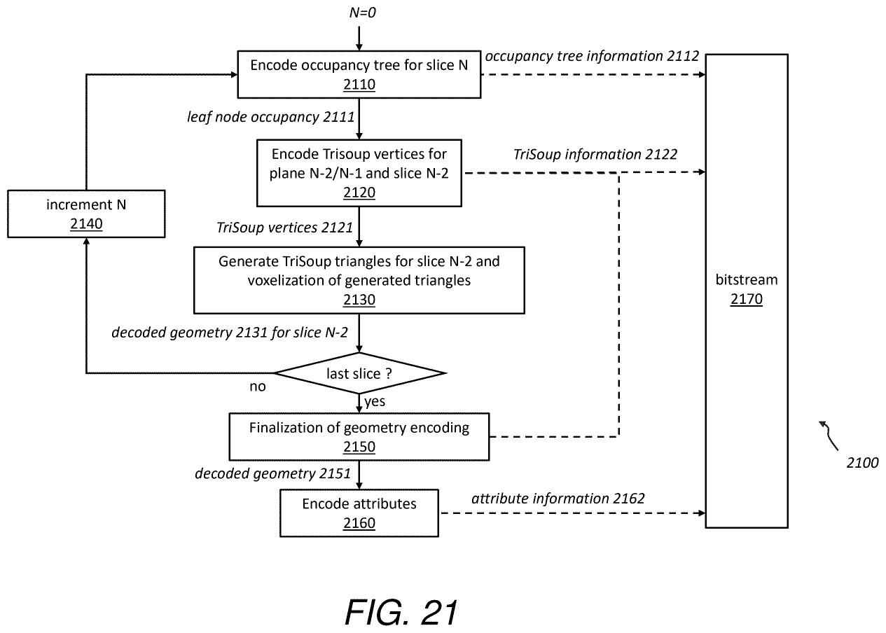

FIG. 21 illustrates an example process 2100 for encoding geometry and attributes of a point cloud using a TriSoup geometry scheme.

The encoding of the geometry is performed slice per slice and starts at slice N=0. A slice is made of leaf nodes of an occupancy tree of the point cloud. At block 2110, an encoder may encode into a bitstream 2170 occupancy tree information 2112 representing the leaf node occupancies 2111 of the leaf nodes of slice N (the occupancy bits of the leaf nodes of slice N). Occupied leaf nodes become TriSoup nodes. At block 2120, the encoder may encode into the bitstream 2170 TriSoup information 2122 relative to TriSoup vertices belonging to edges whose start points are in the plane 2030 (between slice N−2 and slice N−1) and relative to TriSoup centroids located in TriSoup nodes of slice N−2. The encoding of the TriSoup vertices belonging to these edges is possible thanks to the completion of the occupancy tree coding of slice N (more precisely, of the leaf node occupancies 2111 of the leaf nodes of slice N) that allows for the construction of neighboring contextual information for these edges. All TriSoup vertices 2121 for nodes of slice N−2 are therefore encoded. At block 2130, the encoder may generate TriSoup triangles based on the TriSoup vertices 2121 of slice N−2. The encoder may provide a decoded (e.g., reconstructed) geometry 2131 for slice N−2 by voxelization of the generated TriSoup triangles. If the last slice is not reached, the slice index N is incremented, at block 2140, and the geometry encoding continues iteratively until the last slice is reached. Then, at block 2150, the encoder may determine a decoded (e.g., reconstructed) geometry 2151 for all slices by finalizing the geometry encoding for the remaining slices for which TriSoup vertices encoding (e.g., described at block 2120) and triangle generation and voxelization (e.g., described at block 2130) have not been performed yet. The encoder may encode TriSoup information 2122 into the bitstream 2170.

After the geometry has been entirely encoded and decoded, at block 2160, the encoder may encode into the bitstream 2170 attribute information 2162 representing attributes associated with the decoded (e.g., reconstructed) geometry 2151. The attribute encoding (e.g., described at block 2160) is performed after the geometry has been entirely encoded and decoded (e.g., described at block 2150), leading to a non-local two-pass coding scheme with all drawbacks mentioned above in terms of latency, memory footprint and memory traffic.

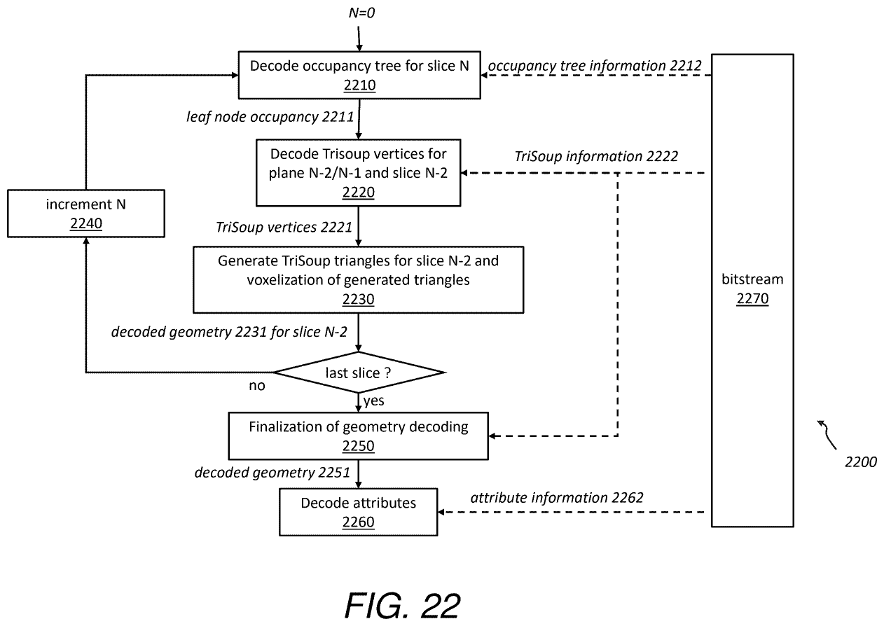

FIG. 22 illustrates an example process 2200 for decoding geometry and attributes of a point cloud using a TriSoup geometry scheme.

This decoding process decodes a bitstream 2270 generated by the encoding process of FIG. 21.

The decoding of the geometry is performed slice per slice and starts at slice N=0. A slice is made of leaf nodes of an occupancy octree of the point cloud. At block 2210, a decoder may determine occupancies of the leaf nodes of slice N 2211 (the occupancy bits of the leaf nodes of slice N) by decoding occupancy tree information 2212 from the bitstream 2270. Occupied leaf nodes become TriSoup nodes. At block 2220, the decoder may decode from the bitstream 2270 TriSoup information 2222 relative to TriSoup vertices belonging to edges whose start points are in the plane 2030 (between slice N−2 and slice N−1) and relative to TriSoup centroids located in TriSoup nodes of slice N−2. The decoding of the TriSoup vertices belonging to these edges is possible thanks to the completion of the occupancy tree coding of slice N (more precisely, of the leaf node occupancies of the leaf nodes of slice N 2211) that allows for the construction of neighboring contextual information for these edges. All TriSoup vertices 2221 for nodes of slice N−2 are therefore decoded. At block 2230, the decoder may generate TriSoup triangles based on the TriSoup vertices 2221 of slice N−2. The decoder may provide a decoded (e.g., reconstructed) geometry 2231 for slice N−2 (same as decoded (e.g., reconstructed) geometry 2131 of FIG. 21) by voxelization of the generated triangles. If the last slice is not reached, the slice index N is incremented, at block 2240, and the geometry decoding continues iteratively until the last slice is reached. Then, at block 2250, the decoder may determine a decoded (e.g., reconstructed) geometry 2251 for all slices by finalizing the geometry decoding for the remaining slices for which TriSoup vertices decoding (e.g., described at block 2220) and triangle generation and voxelization (e.g., described at block 2230) have not been performed yet. The decoder may decode TriSoup information 2222 from the bitstream 2270.

After the geometry has been entirely decoded, at block 2260, the decoder may decode from the bitstream 2270 attribute information 2262 representing of attributes associated with the decoded (e.g., reconstructed) geometry 2251. The attribute decoding (e.g., described at block 2260) is performed after the geometry has been entirely decoded (e.g., described at block 2250), leading to a non-local two-pass coding scheme with all drawbacks mentioned above in terms of latency, memory footprint and memory traffic.

In existing technologies, attribute coding is performed globally on the decoded (e.g., reconstructed) geometry and induces high memory traffic and footprint as well as high computation complexity. The two-pass encoding/decoding on the geometry and then on the attributes, after completion of geometry encoding/decoding, induces even higher memory traffic and footprint as well as overall latency before outputting geometry and attributes of a first point of the decoded point cloud.

Embodiments of the present disclosure are related to an approach for enabling local coding of attributes. In some embodiments, Attribute Coding Units (ACU) are determined by segmenting the overall reconstructed geometry of a point cloud. Each ACU comprises (e.g., contains) at least one point of the reconstructed (e.g., as decoded by the decoder or encoded and then decoded by the encoder) geometry.

In some embodiments, the ACUs of the set of ACUs do not overlap.

The attributes encoding/decoding is localized to portions of the overall decoded (e.g., reconstructed) geometry of a point cloud and the attribute coding of each ACU may be processed locally. Memory traffic and footprint as well as computation complexity are then reduced compared to existing technologies using global attribute coding.

According to the present disclosure, geometry encoding/decoding and attribute encoding/decoding may alternate to address the two-pass problem in existing technologies.

According to another aspect of the present disclosure, the geometry of a point cloud may be restricted to a subset of nodes of the occupancy tree and the restricted geometry and the associated attributes may be encoded/decoded locally by segmenting the restricted geometry into ACUs.

According to another aspect of the present disclosure, the 3D space encompassing a point cloud may be split into regions defined by subsets of nodes of the occupancy tree. The geometry of a first region of the 3D space may be encoded to obtain a first part of the decoded (e.g., reconstructed) geometry that is segmented into a first set of ACUs that are attribute encoded. Then, the geometry of a second region of the 3D space may be encoded to obtain a second part of the decoded (e.g., reconstructed) geometry that is segmented into a second set of ACUs that are attribute encoded, etc. The memory footprint and traffic are thus limited within a few regions, due to some neighborhood prediction between regions, and the latency of the point cloud codec is reduced to the time needed for encoding geometry and attributes of a few regions. Smaller regions will lead to smaller memory footprint and traffic, and to shorter latency.

In the present disclosure, the decoded (e.g., reconstructed) geometry of a point cloud frame may correspond to a reconstructed geometry of the point cloud frame. For example, an encoder may determine the reconstructed geometry based on successively encoding a geometry of the point cloud frame and then decoding the encoded geometry. This reconstructed geometry at the encoder is the same as the geometry as decoded at the decoder; therefore, the decoder may reconstruct the same reconstructed geometry as that at the encoder.

These and other features of the present disclosure are described further below.

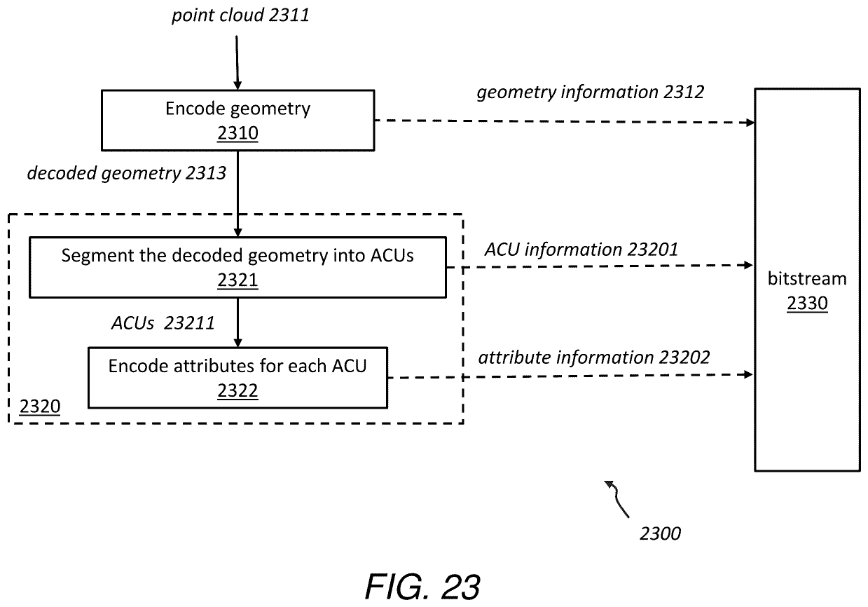

FIG. 23 illustrates an example process 2300 for encoding geometry and attributes of a point cloud, according to some embodiments.

The point cloud 2311 may be a point cloud frame of a sequence of point cloud frames of a dynamic point cloud. At block 2310, an encoder may encode into a bitstream 2330 a geometry information 2312 representative of the geometry of the point cloud 2311. The encoder may provide a decoded e.g., (reconstructed) geometry 2313 of the point cloud 2311. At block 2320, the encoder may encode locally the attributes of points of the decoded (e.g., reconstructed) geometry 2313. Block 2320 comprises blocks 2321 and block 2322. At block 2321, the encoder may segment the decoded (e.g., reconstructed) geometry 2313 into a set of ACUs 23211, each ACU of the set of ACUs comprises at least one point of the point cloud frame. The encoder may encode into the bitstream 2330 an ACU information 23201 that indicates segmentation choices of the decoded (e.g., reconstructed) geometry 2313 into a set of ACUs, e.g. the ACU information 23201 indicates/defines how the decoded (e.g., reconstructed) geometry 2313 is segmented in the set of ACUs.

In some embodiments, the segmentation choices may be determined based on some optimization of attribute coding cost of the attributes of the decoded (e.g., reconstructed) geometry 2313.

At block 2322, the encoder may encode the attributes of points of the decoded (e.g., reconstructed) geometry 2313 (of the point cloud) ACU per ACU. For example, the attributes of points belonging to an ACU of the set of ACUs may be encoded before encoding the attributes of points belonging to another ACU of the set of ACUs. Attribute encoding is thus said local. The encoder may encode attribute information 23202 representative of the encoded attributes.

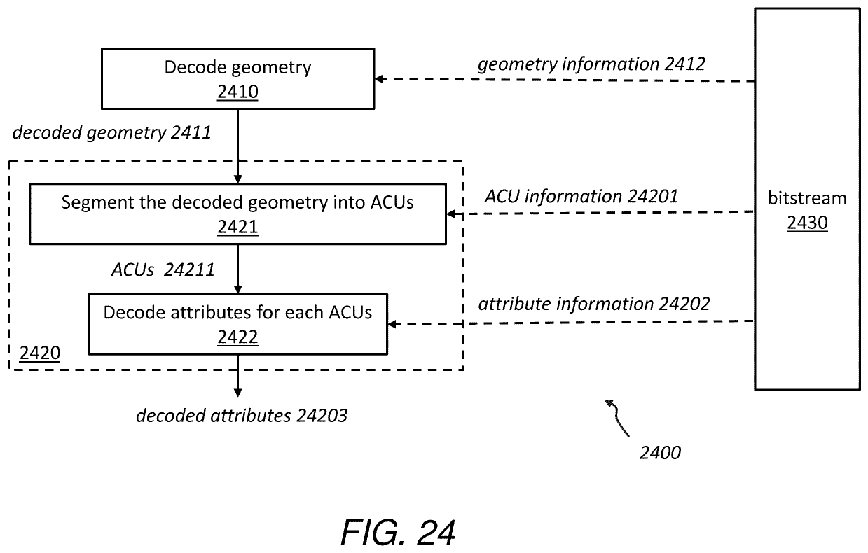

FIG. 24 illustrates an example process 2400 for decoding geometry and attributes of a point cloud, according to some embodiments.

This decoding process decodes a bitstream 2430 generated by the encoding method of FIG. 23. At block 2410, a decoder may determine a decoded (e.g., reconstructed) geometry 2411 of the point cloud by decoding a geometry information 2412 from the bitstream 2430. At block 2420, the decoder may decode locally the attributes of points of the decoded (e.g., reconstructed) geometry 2411. Block 2420 comprises blocks 2421 and 2422. At block 2421, the decoder may segment the decoded (e.g., reconstructed) geometry 2411 into a set of ACUs 24211. Each ACU of the ACUs 24211 comprises at least one point of the point cloud. The decoder may determine segmentation choices by decoding ACU information 24201 from the bitstream 2430, e.g. the decoder may decode, from a bitstream, ACU information defining how the decoded (e.g., reconstructed) geometry 2411 is segmented into the set of ACUs and the decoded (e.g., reconstructed) geometry 2411 is segmented according to the ACU information.

At block 2422, the decoder may determine decoded attributes 24203 of points of the decoded (e.g., reconstructed) geometry 2411 (of a point cloud) ACU per ACU by decoding attribute information 24202 from the bitstream 2430. For example, the attributes belonging to an ACU of the set of ACUs 24211 are determined before determining the attributes of another ACU of the set of ACUs.

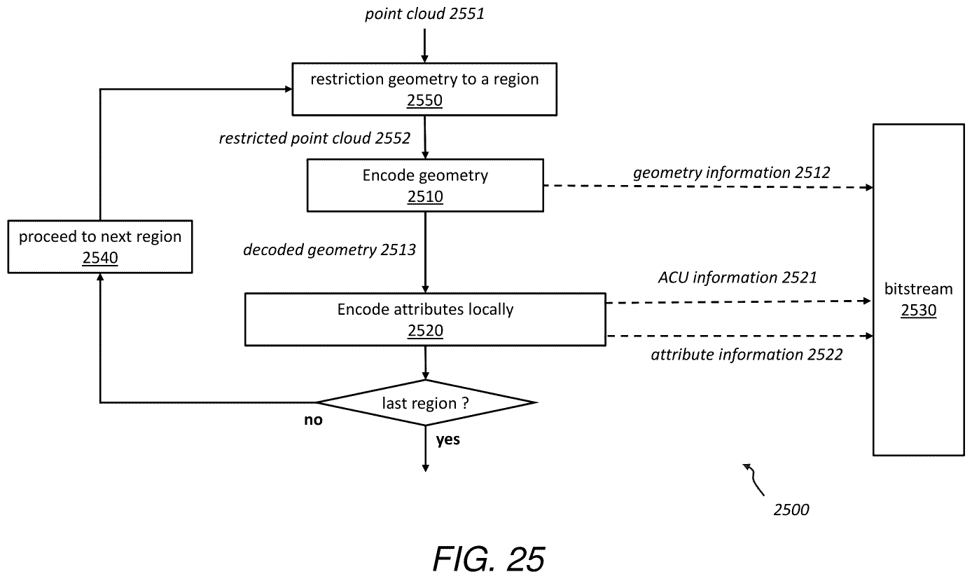

FIG. 25 illustrates an example process 2500 for encoding geometry and attributes of a point cloud, e.g. point cloud 2551, in accordance, according to some embodiments.

The point cloud 2551 may be a point cloud frame of a sequence of point cloud frames of a dynamic point cloud. At block 2550, an encoder may determine a restricted point cloud 2552 by restricting the geometry of the point cloud 2551 to a subset of nodes of the occupancy tree of the point cloud 2551. Said subset of nodes defines a region of the 3D space encompassing the restricted point cloud 2552.

In some embodiments, the encoder may split the geometry of the point cloud 2551 into a set of regions, each region being defined as a subset of nodes of the occupancy tree of the point cloud 2551.

In some embodiments, the regions of the set of regions do not overlap.

In some embodiments, the union of regions of the set of regions equals the set of nodes of the occupancy tree of the point cloud 2551.

Blocks 2510 and 2520 are respectively similar to blocks 2310 and 2320 of FIG. 23.

At block 2510, the encoder may encode into a bitstream 2530 a geometry information 2512 representative of the geometry of the restricted point cloud 2552. The encoder may provide a decoded (e.g., reconstructed) geometry 2513 of the restricted point cloud 2552. At block 2520 (same as block 2320 of FIG. 23), the encoder may encode locally the attributes of the decoded (e.g., reconstructed) geometry 2513. The encoder may encode into the bitstream 2530 an ACU information 2521 that indicates segmentation choices of the decoded (e.g., reconstructed) geometry 2513 into a set of ACUs and the encoder may encode the attributes of a set of ACUs as attribute information 2522.

In some embodiments, the segmentation choices may be determined based on some optimization of attribute coding cost of the attributes of the decoded (e.g., reconstructed) geometry 2513.

The method of geometry and attribute encoding of a restricted point cloud (e.g., described at blocks 2550, 2510 and 2520) may be looped over a set of regions (e.g., described at block 2540) that may cover the 3D space encompassing the point cloud 2551. Once the loop has processed all restricted points clouds (all regions of the set of regions), geometry, ACU and attribute information have been encoded into the bitstream 2530 for the entire point cloud 2551.

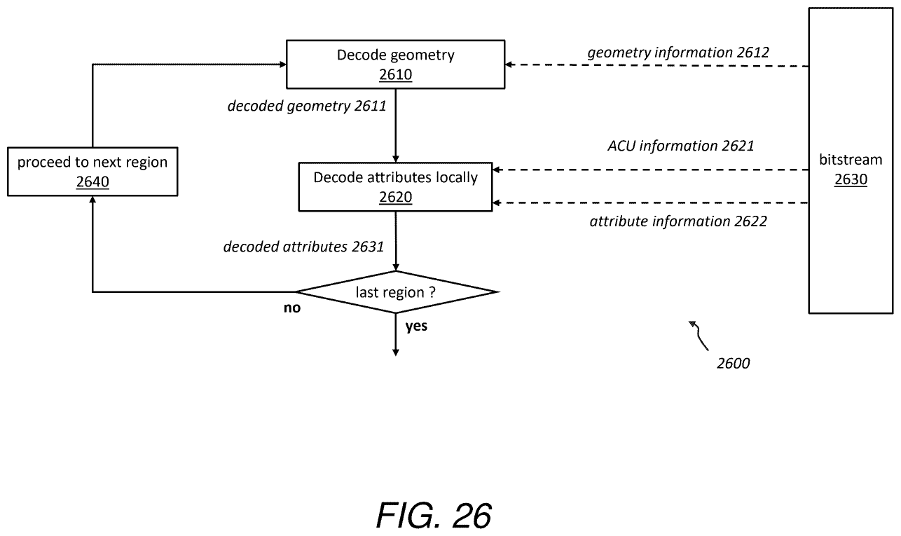

FIG. 26 illustrates an example process 2600 for decoding geometry and attributes of a point cloud in accordance, according to some embodiments.

This decoding process decodes a bitstream 2630 generated by the encoding process of FIG. 25. Blocks 2610 and 2620 are respectively similar to blocks 2410 and 2420 of FIG. 24.

At block 2610, a decoder may determine a decoded (reconstructed) geometry 2611 of a restricted point cloud by decoding a geometry information 2612 from a bitstream 2630. The geometry of the restricted point cloud may be defined as a restriction of a geometry of an entire point cloud to a region of the 3D space encompassing said entire point cloud. A region may be defined as a subset of nodes of the occupancy tree of said entire point cloud.

In some embodiments, said region may belong to a set of regions that split the geometry of said entire point cloud, e.g., that split the 3D space encompassing said entire point cloud.

In some embodiments, regions of the set of regions do not overlap.

In some embodiments, the union of regions of the set of regions equals the set of nodes of the occupancy tree of said entire point cloud.

At block 2620, same as block 2420 of FIG. 24, the decoder may decode locally the attributes of points of the decoded (reconstructed) geometry 2611 by decoding ACU information 2621 and attribute information 2622 from the bitstream 2630. ACU information 2621 may provide segmentation choices of the decoded (reconstructed) geometry 2611 into a set of ACUs and attribute information 2622 may provide information for decoding attributes of each ACU of said set of ACUs.

The method of geometry and attribute decoding of a restricted point cloud (e.g., described at blocks 2610 and 2620) may be looped over a set of regions (e.g., described at block 2640) that may cover the 3D space encompassing an entire point cloud. Once the loop has processed all restricted points clouds (all regions of the set of regions), geometry, ACU and attribute information have been decoded from the bitstream 2530 for the entire point cloud.

Segmenting a decoded (reconstructed) geometry of a point cloud into ACUs and encoding attributes for each ACUs may be applied to the example encoding method of FIG. 21 and the example decoding method of FIG. 22.

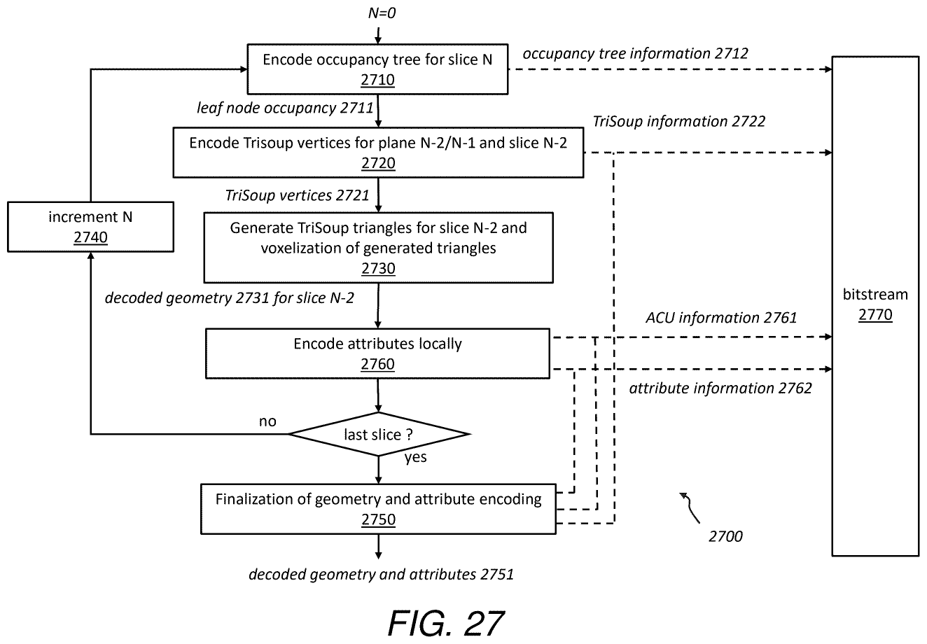

FIG. 27 illustrates an example process 2700 for encoding geometry and attributes of a point cloud, according to some embodiments.

Blocks 2710, 2720, 2730 and 2740 are the same as blocks 2110, 2120, 2130 and 2140 of FIG. 21.

The encoding of the geometry is performed slice per slice and starts at slice N=0. Each slice comprises at least one TriSoup node. At block 2710, an encoder may encode into a bitstream 2770 occupancy tree information 2712 representing the leaf node occupancies 2711 of the leaf nodes of slice N. Occupied leaf nodes become TriSoup nodes. At block 2720, the encoder may encode into the bitstream 2770 TriSoup information 2722 relative to TriSoup vertices belonging to edges whose start points are in the plane 2030 (between slice N−2 and slice N−1) and relative to TriSoup centroids located in TriSoup nodes of slice N−2. All TriSoup vertices 2721 for nodes of slice N−2 are therefore encoded. At block 2730, the encoder may generate TriSoup triangles based on the TriSoup vertices 2721 of slice N−2. The encoder may provide a decoded (reconstructed) geometry 2731 for slice N−2 by voxelization of the generated TriSoup triangles. At block 2760 (same as block 2320 of FIG. 23), the encoder may encode locally the attributes of the decoded (reconstructed) geometry 2731. The encoder may encode into the bitstream 2770 an ACU information 2761 that indicates segmentation choices of the decoded (reconstructed) geometry 2731 into a set of ACUs and the attributes of the set of ACUs as attribute information 2762.

In some embodiments, the segmentation choices may be determined based on some optimization of attribute coding cost of the attributes of the decoded (reconstructed) geometry 2731.

If the last slice is not reached, the slice index N is incremented, at block 2740, and the joint geometry and attribute encoding continues iteratively slice per slice until the last slice is reached.

The global attribute encoding (e.g., described at block 2160 of FIG. 21) is replaced by a local attribute coding (e.g., described at block 2760) that operates after the generation, at block 2730, of the decoded (reconstructed) geometry 2731 for slice N−2. This allows an alternate encoding of geometry and attributes of points of a slice of a decoded (reconstructed) geometry of a point cloud.

Then, at block 2750, the encoder may determine decoded (reconstructed) geometry and attributes 2751 for all slices by finalizing the joint geometry and attribute encoding for the remaining slices for which TriSoup vertices encoding (e.g., described at block 2720), triangle generation and voxelization (e.g., described at block 2730) and local attribute encoding (e.g., described at block 2760) have not been performed yet. The encoder may encode into the bitstream 2770 attribute information 2762 representing attributes associated with the decoded (reconstructed) geometry 2731, ACU information 2761 and TriSoup information 2722.

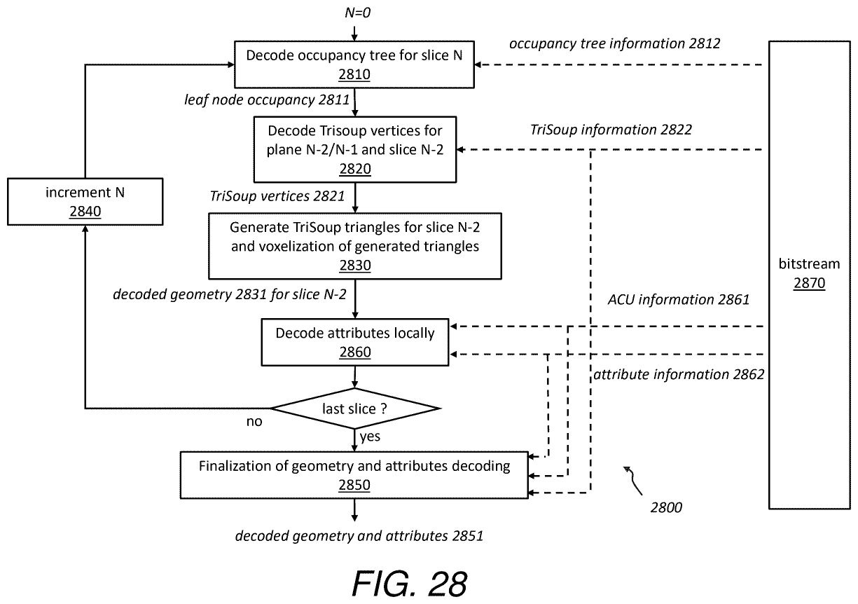

FIG. 28 illustrates an example process 2800 for decoding geometry and attributes of a point cloud using a TriSoup geometry scheme, according to some embodiments.

Blocks 2810, 2820, 2830 and 2840 are the same as blocks 2210, 2220, 2230 and 2240 of FIG. 22. This decoding process decodes a bitstream 2870 generated by the encoding method of FIG. 27.

The decoding of the geometry is performed slice per slice and starts at slice N=0. Each slice comprises at least one TriSoup node. At block 2810, a decoder may determine occupancies of the leaf nodes of slice N 2811 (the occupancy bits of the leaf nodes of slice N) by decoding occupancy tree information 2812 from the bitstream 2870. Occupied leaf nodes become TriSoup nodes. At block 2820, the decoder may decode from the bitstream 2870 TriSoup information 2822 relative to TriSoup vertices belonging to edges whose start points are in the plane 2030 (between slice N−2 and slice N−1) and relative to TriSoup centroids located in TriSoup nodes of slice N−2. All TriSoup vertices 2821 for nodes of slice N−2 are therefore decoded. At block 2830, the decoder may generate TriSoup triangles based on the TriSoup vertices 2821 of slice N−2. The decoder may provide a decoded (reconstructed) geometry 2831 for slice N−2 (same as decoded (reconstructed) geometry 2231 of FIG. 22) by voxelization of the generated triangles. At block 2860, same as block 2420 of FIG. 24, the decoder may decode locally the attributes of the points of the decoded (reconstructed) geometry 2831 by decoding ACU information 2861 and attribute information 2822. ACU information 2861 may provide segmentation choices of the decoded (reconstructed) geometry 2831 into a set of ACUs and attribute information 2862 may provide information for decoding attributes of each ACU of said set of ACUs.

If the last slice is not reached, the slice index N is incremented, at block 2840, and the geometry decoding continues iteratively until the last slice is reached.

The global attribute decoding (e.g., described at block 2260 of FIG. 22) is replaced by a local attribute coding (e.g., described at block 2860) that operates after the generation, at block 2830, of the decoded (reconstructed) geometry 2831 for slice N−2. This allows an alternate decoding of geometry and attributes of points of a slice of a decoded (reconstructed) geometry of a point cloud.

Then, at block 2850, the decoder may determine decoded (reconstructed) geometry and attributes 2851 for all slices by finalizing the geometry and attribute decoding for the remaining slices for which TriSoup vertices decoding (e.g., described at block 2820), triangle generation and voxelization (e.g., described at block 2830) and local attribute decoding (e.g., described at block 2860) have not been performed yet. The decoder may decode from the bitstream 2870 attribute information 2862 representing attributes associated with the decoded (reconstructed) geometry 2831, ACU information 2861 and TriSoup information 2822. In some embodiments, ACU information may indicate that each ACU correspond to a TriSoup node of an occupancy tree associated with the point cloud.

In some embodiments, ACU information may indicate that at least one ACU of a set of ACUs corresponds to more than one TriSoup nodes of an occupancy tree associated with the point cloud. This is advantageous when TriSoup nodes are too small to obtain efficient attribute coding.

In some embodiments, ACU information may indicate that an ACU of a set of ACUs corresponds to all TriSoup nodes of the slice N−2.

In some embodiments, ACU information may indicate that the decoded (reconstructed) geometry is segmented into a set of ACUs that intersect several slices of TriSoup nodes.

This embodiment may be advantageous when TriSoup nodes are small because slices have then small width and local attribute coding on thin slices may not be efficient. Segmenting the decoded (reconstructed) geometry into a set of ACUs that intersect several slices of TriSoup nodes provide thicker ACUs such as to improve the compression performance of local attribute coding at the cost of a slightly increased latency (several slices of latency instead of one slice of latency between geometry and attribute coding).

In some embodiments, ACUs of a set of ACUs are ordered according to an ACU coding (decoding) order and each current ACU whose attributes have to be encoded/decoded is selected according to the ACU coding (decoding) order, e.g. the attributes of the points belonging to a current ACU in the set of ordered ACUs are encoded/decoded before encoding/decoding attributes of points of the point cloud belonging to a next ACU in the set of ordered ACUs. In some embodiments, said ACU coding (decoding) order may follow an implicit scanning order.

In some embodiments, said ACU coding (decoding) order may comprise a raster scan order used for scanning the nodes of a slice of the point cloud (FIG. 17).

In some embodiments, said ACU coding (decoding) order may be decided by the encoder and ACU coding order may be signaled in a bitstream. In some examples, the ACU information (23201, 24201, 2521, 2621, 2761, 2861) may indicate said decided ACU coding order.

The local attribute coding over one ACU may not have optimal attribute compression performance due, in particular, to the cost of coding a mean value of attributes of an ACU.

In some embodiments, encoding/decoding attributes of points of an ACU may be based on ACU attribute prediction.

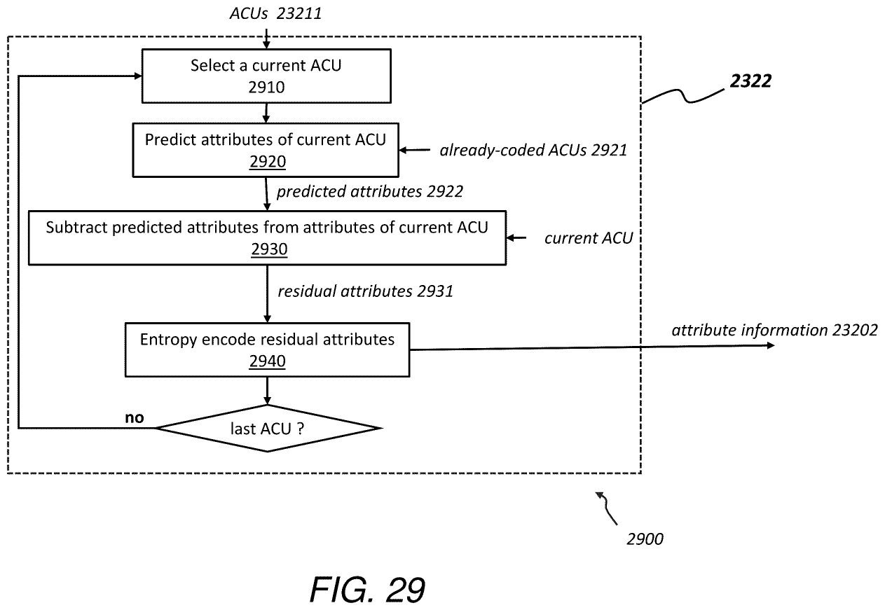

FIG. 29 illustrates an example process 2900 for encoding attributes of an ACU (e.g., described at block 2322), according to some embodiments.

At block 2910, the encoder may select a current ACU from the set of ACUs 23211.

At block 2920, the encoder may determine predicted attributes 2922 by predicting the attributes of the current ACU based on attributes of points of at least one already-coded ACU 2921. At block 2930, the encoder may determine residual attributes 2931 based on differences between the predicted attributes 2922 and the attributes of points of the current ACU. For example, the predicted attributes 2922 may be subtracted from the attributes of the points of the current ACU. In other words, the residual attributes 2931 may represent the differences. At block 2940, the encoder may entropy encode the residual attributes 2931 as attribute information 23202. A next current ACU is selected (e.g., described at block 2910) and attributes of said next current ACU are encoded (e.g., described at blocks 2920, 2930 and 2940) until all the ACUs of the set of ACUs 23211 are selected.

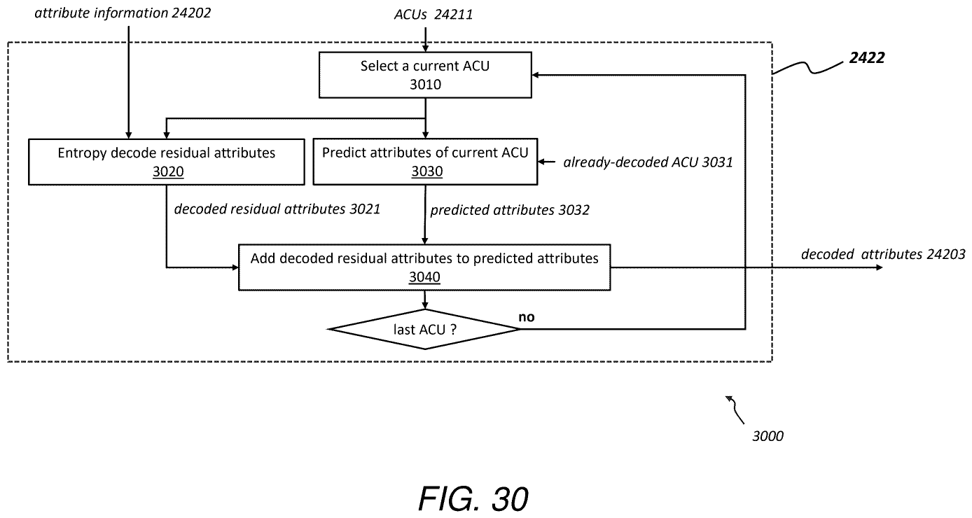

FIG. 30 illustrates an example process 3000 for decoding attributes of an ACU (e.g., described at block 2422), according to some embodiments.

At block 3010, the decoder may select a current ACU from the set of ACUs 24211. At block 3020, the decoder may determine residual attributes 3021 by entropy decoding attribute information 24202. At block 3030, the decoder may determine predicted attributes 3032 (same as predicted attributes 2922 of FIG. 29) from attributes of points of at least one already-decoded ACU 3031. At block 3040, the decoder may determine decoded attributes 24203 of points of the current ACU based on adding the decoded residual attributes 3021 to the predicted attributes 3032. A next current ACU is selected (e.g., described at block 3010) and attributes of the next current ACU decoded (e.g., described at blocks 3020, 3030 and 3040) until all the ACUs of the set of ACUs 24211 are selected.

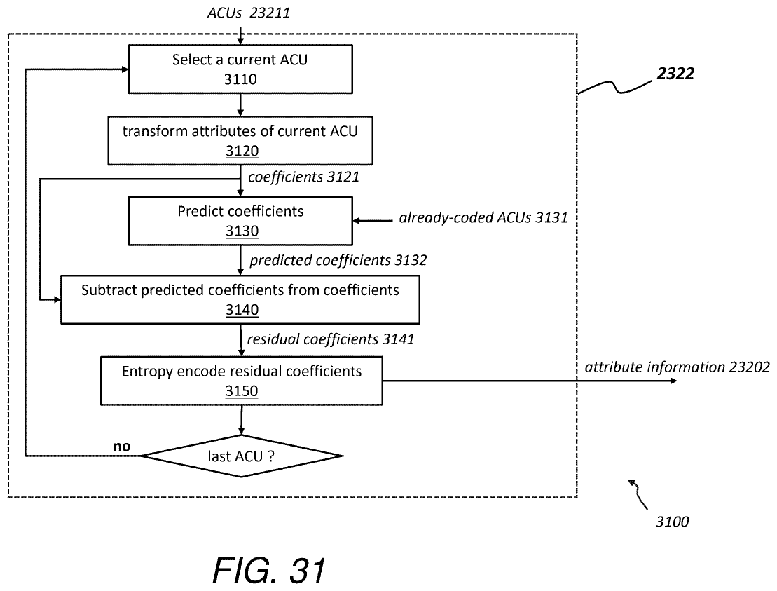

FIG. 31 illustrates an example process 3100 for encoding attributes of an ACU, (e.g., described at block 2322) according to some embodiments.

At block 3110, the encoder may select a current ACU from the set of ACUs 23211. At block 3120, the encoder may determine coefficients 3121 of the current ACU based on applying a 3D transform on the attributes of points of the current ACU. At block 3130, the encoder may determine predicted coefficients 3132 by predicting the coefficients 3121 of the current ACU based on attributes of points of at least one already-coded ACU 3131. At block 3140, the encoder may determine residual coefficients 3141 based on differences between the predicted coefficients 3132 and the coefficients 3121 of the current ACU. For example, the predicted coefficients 3132 maybe subtracted from the coefficients 3121. At block 3150, the encoder may entropy encode the residual coefficients 3141 as attribute information 23202. A next current ACU is selected (e.g., described at block 3110) and attributes of the next current ACU encoded (e.g., described at blocks 3120, 3130, 3140 and 3150) until all the ACUs of the set of ACUs 23211 are selected.

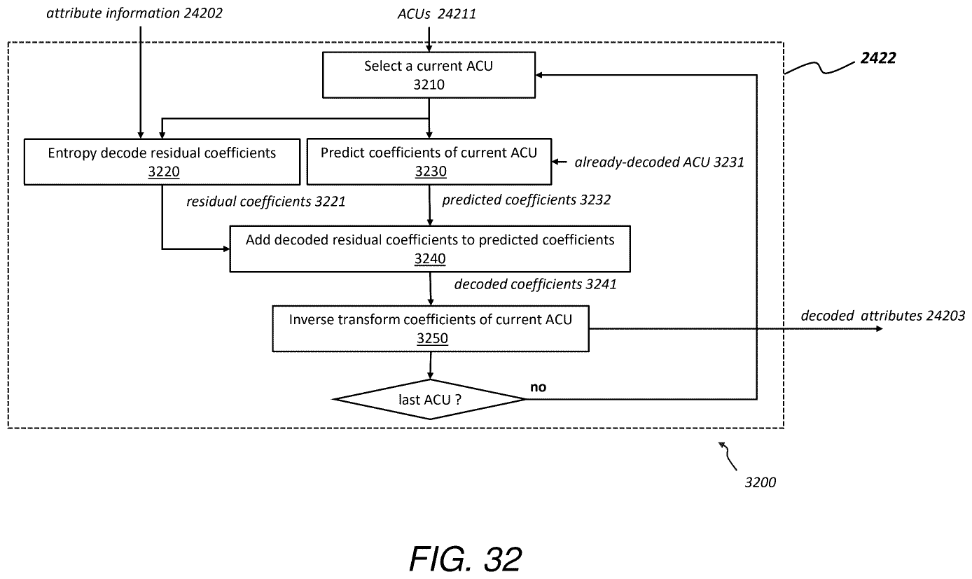

FIG. 32 illustrates an example process 3200 for decoding attributes of an ACU (e.g., described at block 2422), according to some embodiments.

At block 3210, the decoder may select a current ACU from the set of ACUs 24211. At block 3220, the decoder may determine residual coefficients 3221 of the current ACU by entropy decoding attribute information 24202. At block 3230, the decoder may determine predicted coefficients 3232 (e.g., same as predicted coefficients 3132 of FIG. 31) based on attributes of points of at least one already-decoded ACU 3231. At block 3240, the decoder may determine coefficients 3241 of the current ACU based on adding the decoded residual coefficients 3221 to the predicted coefficients 3232. At block 3250, the decoder may determine decoded attributes 24203 of points of the current ACU by applying a 3D inverse transform to the coefficients 3241. A next current ACU is selected (e.g., described at block 3210) and decoded attributes of points of the next current ACU decoded (e.g., described at blocks 3220, 3230, 3240, and 3250) until all the ACUs of the set of ACUs 24211 are selected.

In some embodiments, coefficients may comprise a DC coefficient and at least one AC coefficient, said DC coefficient being representative of a mean attribute in an ACU.

In some embodiments, the 3D transform may comprise a RAHT and the 3D inverse transform may comprise an inverse RAHT Then, the attributes of the decoded (reconstructed) geometry of points belonging to an ACU may be encoded/decoded by a RAHT scheme restricted to said ACU.

In some embodiments, the encoder may then provide a DC coefficient c_{ACU} representative of the sum of attributes over the points of the decoded (reconstructed) geometry belonging to the ACU.

In some embodiments, the 3D transform may comprise a Haar transform and the inverse 3D transform may comprise the inverse Haar transform.

In some embodiments, the 3D transform may comprise an Adaptive-DCT and the inverse intra transform may comprise an inverse Adaptive-DCT (A-DCT) that is an adaptation of the DCT transform to domains with holes.

Prediction of attributes of ACU is said intra (intra ACU attribute prediction) when the current ACU and said at least one already-coded ACU 2921 (e.g., already-coded ACUs 3131) (or already-decoded ACU 3031, 3231) belong to a same point cloud frame.

Intra ACU attribute prediction of a current ACU may be performed for each attribute of the current ACU (for attribute of each point of the ACU).

In some embodiments, said at least one already-coded ACU 2921 (e.g., already-coded ACUs 3131) (or already-decoded ACU 3031, 3231) may comprise a spatial neighbor ACU of a current ACU.

In some embodiments, the spatial neighbor ACU may comprise an ACU having a part of its boundary overlapping with at least a portion of a boundary of the current ACU. For example, when ACU have cuboid shape, boundary may be defined as faces, edges and vertices of the cuboid. Sharing a part of the boundary may be defined as having a common face, a common edge or a common edge.

In some embodiments, intra ACU attribute prediction may be based on spatial extrapolation of at least one attribute of said at least one already-coded ACU (e.g., already-coded ACUs 2921 or 3131) (or already-decoded ACU 3031, 3231).

For example, spatial extrapolation of attributes of spatial neighbors ACU (2921, 3131, 3031, 3231) of a current ACU may be determined by fitting a 3D attribute model for the attributes of said spatial neighbors ACU, and by extending (e.g., extrapolating) the fitted model to the current ACU. A 3D attribute model may take spatial coordinates as input and provide modeled attributes as output; model parameters are fit (e.g., learned) on the attributes of spatial neighbors ACU of the current ACU.

In some embodiments, intra ACU attribute prediction may be based on an average of attributes of said at least one already-coded ACU 2921 (e.g., already-coded ACUs 3131) (or already-decoded ACU 3031, 3231).

Prediction of attributes of ACU is said inter (inter ACU attribute prediction) when the current ACU belongs to a current point cloud frame and said at least one already-coded ACU 2921 (e.g., already-coded ACUs 3131) (or already-decoded ACU 3031, 3231) belong to an already-coded (decoded) point cloud frame different of the current point cloud frame. Said already-coded (decoded) point cloud frame is named attribute reference point cloud frame.

Inter ACU attribute prediction of a current ACU may be performed for each attribute of the current ACU (for attribute of each point of the ACU).

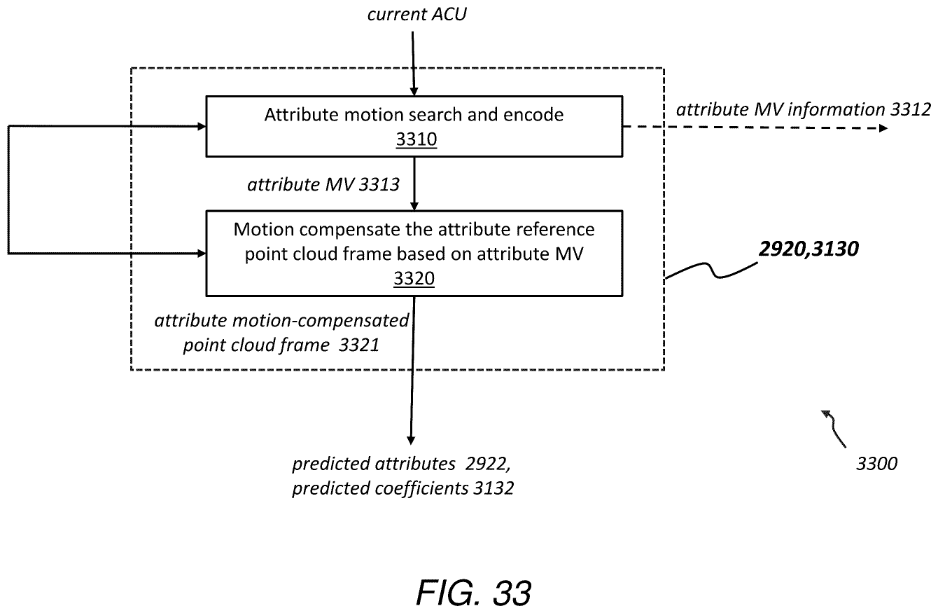

FIG. 33 illustrates an example process 3300 for inter encoding attributes of a current ACU, according to some embodiments.

The at least one already-coded ACU 2921 of FIG. 29 (or already-coded ACU 3131 of FIG. 31) may belong to an already-coded attribute reference point cloud frame 3311 that may be obtained by the encoder for example among multiple already-coded attribute reference point cloud frames. At block 3310, the encoder may determine attribute motion vectors (MV) 3313 by performing an attribute motion search such as that attribute MV 3313 best approximate the 3D motion field of attributes from the attribute reference point cloud frame 3311 to the attributes of the current ACU. The encoder may encode attribute MV information 3312 into the bitstream 2330 as a representation of the attribute MV 3313. Attribute MV information 3312 may be part of attribute information 23202 (FIG. 23). The attribute motion search (e.g., described at block 3310) is typically an iterative method that tests locally multiple candidate attribute motion vectors, and selects the candidate attribute motion vector, among the candidate attribute motion vectors, that minimizes an attribute distortion between the attributes of the current ACU and attributes determined by motion compensation of the attributes of the attribute reference point cloud frame 3311 using the candidate attribute motion vector. At block 3320, the encoder may determine an attribute motion-compensated point cloud frame 3321 by performing a motion compensation of the attribute reference point cloud frame 3311 based on the attribute MV 3313. The encoder may determine the predicted attributes 2922 (e.g., comprising predicted coefficients 3132) from the attributes of the attribute motion-compensated point cloud frame 3321.

In some embodiments, the attribute distortion, used by the attribute motion search, for a point of the current ACU may be determined by comparing the attribute of this point and the attribute of (one of) its closest neighbor in the attribute motion-compensated point cloud frame 3321.

In some embodiments, the encoder may determine the predicted attributes 2922 of points of the current ACU as being the attributes of the attribute motion-compensated point cloud frame 3321.

In some embodiments, the encoder may determine the predicted attributes 2922 of points of the current ACU by determining projected attributes based on projecting the attributes of the attribute motion-compensated point cloud frame 3321 on a decoded (reconstructed) geometry of the current ACU obtained from geometry information 2412 and ACU information 24201 (e.g., described at blocks 2410 and 2421 of FIG. 24) and determining the predicted attributes 2922 as being the projected attributes.

In some embodiments, the encoder may determine the predicted coefficients 3132 based on transforming the attributes of points belonging to a co-located ACU in the attribute motion-compensated point cloud frame 332.

In some embodiments, the encoder may encode an ACU attribute coding mode, from a plurality of ACU attribute coding modes, in the bitstream 2330 as part of the ACU information 23201 or part of the attribute information 23202. The ACU attribute coding mode may indicate whether an ACU is encoded directly, e.g., whether the attributes of points of the current ACU are encoded independently of already-coded ACU, or by using either intra or inter attribute prediction.

In some embodiment, the plurality of ACU attribute coding modes may comprise a first ACU attribute coding mode indicating the at least one already-coded ACU belongs to a same point cloud frame as the current point cloud frame; and a second ACU attribute coding mode indicating the current ACU belongs to a current point cloud frame and the at least one already-coded ACU belongs to an already-coded point cloud frame different from the current point cloud frame.

In some embodiments, the plurality of ACU attribute coding modes further comprises a third ACU attribute coding mode indicating the attributes of the points of the current ACU are encoded or decoded independently of any already-coded ACUs.

In some embodiments, when the ACU attribute coding mode indicates the use of inter attribute prediction, the encoder may encode an indication of the attribute reference point cloud frame used for inter prediction. The indication may be part of the of the ACU information 23201 or part of the attribute information 23202.

In some embodiments, the encoder may encode in the bitstream 2330, an ACU attribute coding mode per ACU.

In some embodiments, the encoder may encode in the bitstream 2330, an ACU attribute coding mode for a set of ACUs.

In some embodiments, the encoder may encode in the bitstream 2330, a single ACU attribute coding mode for all ACUs.

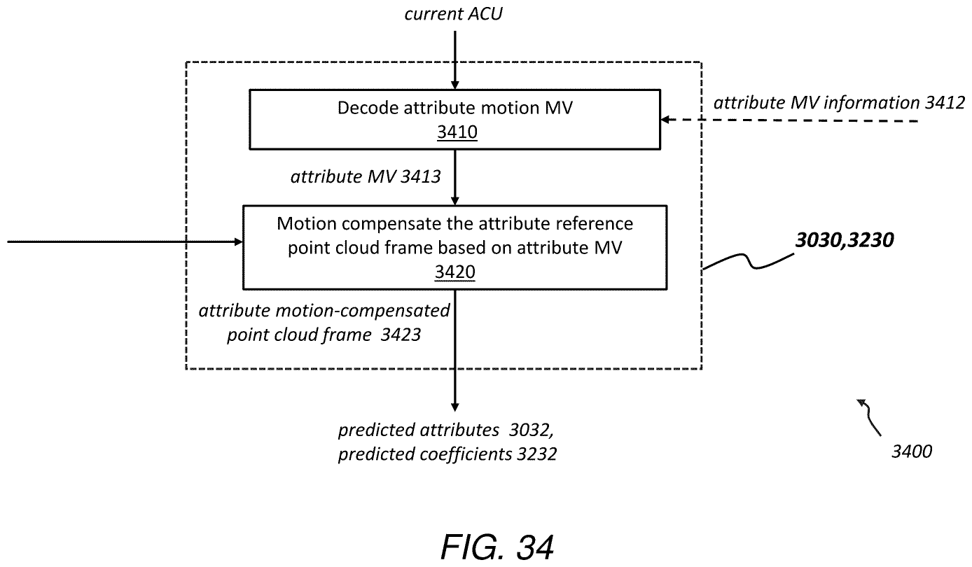

FIG. 34 illustrates an example process 3400 for inter decoding attributes of a current ACU, according to some embodiments.

The decoding process may decode attributes of a current ACU encoded by the encoding process of FIG. 33. The at least one already-decoded ACU 3031 of FIG. 30 (or already-coded ACU 3231 of FIG. 32) may belong to an already-decoded attribute reference point cloud frame 3421 that may be obtained by the decoder for example among multiple already-decoded attribute reference point cloud frames. The decoder may determine the attribute reference point cloud frame 3421 by decoding attribute MV information 3412. At block 3410, the decoder may determine attribute MV 3413 by decoding attribute MV information 3412. The attribute MV 3313 and 3413 are the same. At block 3420, the decoder may determine an attribute motion-compensated point cloud frame 3423 by performing a motion compensation of the attribute reference point cloud frame 3421 based on the attribute MV 3413.

In some embodiments, the decoder may determine the predicted attributes 3032 of points of the current ACU as being the attributes of the attribute motion-compensated point cloud frame 3423.

In some embodiments, the decoder may determine the predicted attributes 3032 of points of the current ACU by determining projected attributes by projecting the attributes of the attribute motion-compensated point cloud frame 3423 on a decoded (reconstructed) geometry of the current ACU obtained from geometry information 2412 and ACU information 24201 (e.g., described at blocks 2410 and 2421 of FIG. 24) and by determining the predicted attributes 3032 as being the projected attributes.

In some embodiments, the decoder may determine the predicted coefficients 3232 by transforming the attributes of points belonging to a co-located ACU in the attribute motion-compensated point cloud frame 3423.

In some embodiments, the decoder may decode an ACU attribute coding mode from the bitstream 2430 as part of the ACU information 24201 or part of the attribute information 24202. The ACU attribute coding mode may indicate whether an ACU is decoded directly, i.e., whether the attributes of points of the current ACU are decoded independently of already-coded ACU, or by using either intra or inter attribute prediction.

In some embodiments, when the ACU attribute coding mode indicates the use of inter attribute prediction, the decoder may decode an ACU attribute reference point cloud frame information indicating the attribute reference point cloud frame used for inter prediction. The ACU attribute reference point cloud frame information may be part of the of the ACU information 24201 or part of the attribute information 24202.

In some embodiments, the decoder may decode from the bitstream 2430, an ACU attribute coding mode per ACU.

In some embodiments, the decoder may decode from the bitstream 2430, an ACU attribute coding mode for a set of ACUs.

In some embodiments, the decoder may decode from the bitstream 2430, a single ACU attribute coding mode for all ACUs.

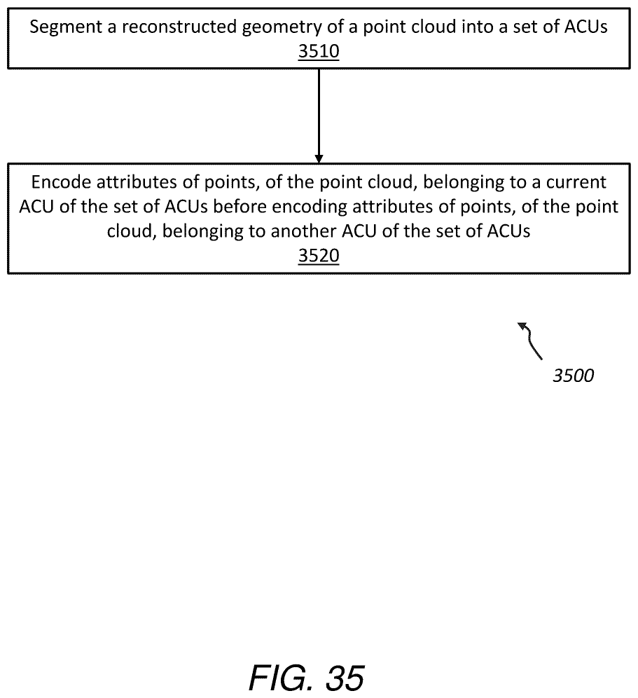

FIG. 35 illustrates a flowchart 3500 of an example method for encoding attributes of a point cloud frame (e.g., a current point cloud frame), according to some embodiments. The method of flowchart 3500 may be implemented by an encoder, such as encoder 114 in FIG. 1. In some examples, the method of flowchart 3500 may correspond to the process 2300 of FIG. 23. In some examples, the encoder may comprise a geometry encoder, a geometry segmenter and an attributes encoder which are represented in process 2300. In some examples, the method of flowchart 3500 may correspond to the process 2700 of FIG. 27. In some examples, the encoder may comprise a geometry encoder, a local attributes encoder, a TriSoup vertices encoder and a TriSoup triangles generator, which are represented in process 2700.

At block 3510, an encoder segments a decoded (reconstructed) geometry of a point cloud into a set of attribute coding units (ACUs), wherein each ACU of the ACUs comprises at least one point of the point cloud. As explained above, on the encoder side, an encoder may determine a reconstructed geometry based on encoding the geometry and then subsequently decoding the encoded geometry. This reconstructed geometry may correspond (e.g., be the same as) to a decoded geometry on the decoder side.

At block 3520, the encoder encodes attributes of points, of the point cloud, belonging to a current ACU of the set of ACUs before encoding attributes of points, of the point cloud, belonging to another ACU of the set of ACUs.

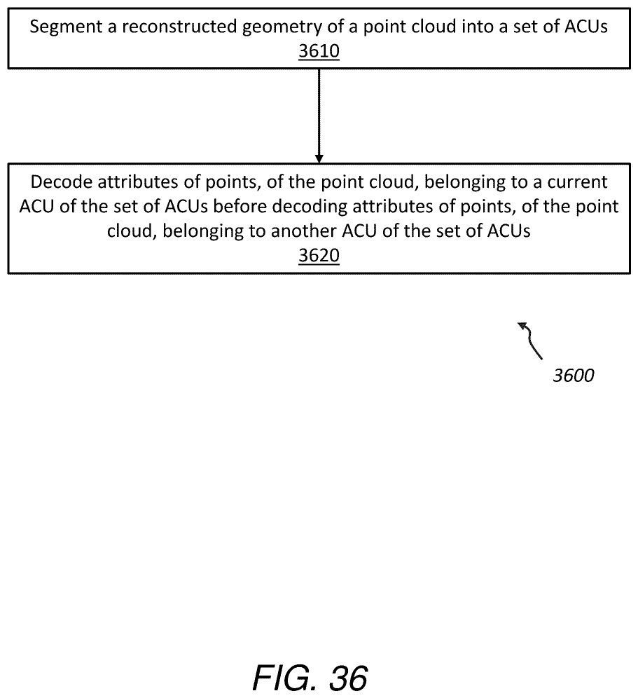

FIG. 36 illustrates a flowchart 3600 of an example method for decoding attributes of a point cloud frame (e.g., a current point cloud frame), according to some embodiments. The method of flowchart 3600 may be implemented by a decoder, such as decoder 120 in FIG. 1. The method of flowchart 3600 may be implemented by a decoder, such as decoder 120 in FIG. 1. In some examples, the method of flowchart 3600 may correspond to the process 2400 of FIG. 24. In some examples, the decoder may comprise a geometry decoder, a geometry segmenter and an attributes decoder which are represented in process 2300. In some examples, the method of flowchart 3600 may correspond to the process 2800 of FIG. 28. In some examples, the decoder may comprise a geometry decoder, a local attributes decoder, a TriSoup vertices decoder and a TriSoup triangles generator, which are represented in process 2800.

At block 3610, the decoder segments a decoded (reconstructed) geometry of a point cloud into a set of attribute coding units (ACUs), each ACU containing at least one point of the point cloud.

At block 3620, the decoder decodes attributes of points, of the point cloud, belonging to a current ACU of the set of ACUs before decoding attributes of points, of the point cloud, belonging to another ACU of the set of ACUs.

References in the specification to encoding information (occupancy tree information, TriSoup information, attribute information, geometry information, ACU information, attribute MV information) indicate encoding information as at least one single bit (flag) or as at least one word comprising each more than one bit or as a combination of at least one flag and at least one word. Encoding information into a bitstream indicates writing into the bitstream at least one single bit (flag) or at least one word comprising each more than one bit or a combination of at least one flag and at least one word representing the information according to a specific syntax.

References in the specification to decoding information (occupancy tree information, TriSoup information, attribute information, geometry information, ACU information, attribute MV information) indicate decoding information from at least one single bit (flag) or from at least one word comprising each more than one bit or from a combination of at least one flag and at least one word. Decoding information from a bitstream indicates parsing the bitstream according to a specific syntax and reading from the bitstream at least one single bit (flag) or at least one word comprising each more than one bit or a combination of at least one flag and at least one word representing the information.

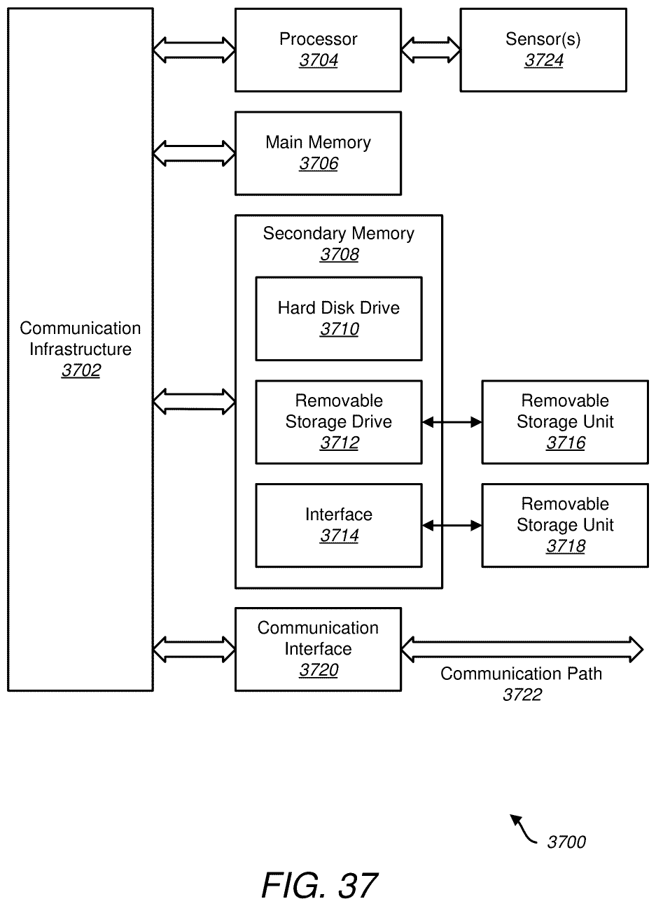

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 3700 is shown in FIG. 37. Blocks depicted in the figures above, such as the blocks in FIG. 1, 6, 10-14, 17-32, may execute on one or more computer systems 3700. Furthermore, each of the steps of the flowcharts depicted in this disclosure may be implemented on one or more computer systems 3700. When more than one computer system 3700 is used to implement embodiments of the present disclosure, the computer systems 3700 may be interconnected by one or more networks to form a cluster of computer systems that may act as a single pool of seamless resources. The interconnected computer systems 3700 may form a “cloud” of computers.

Computer system 3700 includes one or more processors, such as processor 3704. Processor 3704 may be, for example, a special purpose processor, general purpose processor, microprocessor, or digital signal processor. Processor 3704 may be connected to a communication infrastructure 3702 (for example, a bus or network). Computer system 3700 may also include a main memory 3706, such as random access memory (RAM), and may also include a secondary memory 3708.

Secondary memory 3708 may include, for example, a hard disk drive 3710 and/or a removable storage drive 3712, representing a magnetic tape drive, an optical disk drive, or the like. Removable storage drive 3712 may read from and/or write to a removable storage unit 3716 in a well-known manner. Removable storage unit 3716 represents a magnetic tape, optical disk, or the like, which is read by and written to by removable storage drive 3712. As will be appreciated by persons skilled in the relevant art(s), removable storage unit 3716 includes a computer usable storage medium having stored therein computer software and/or data.

In alternative implementations, secondary memory 3708 may include other similar means for allowing computer programs or other instructions to be loaded into computer system 3700. Such means may include, for example, a removable storage unit 3718 and an interface 3714. Examples of such means may include a program cartridge and cartridge interface (such as that found in video game devices), a removable memory chip (such as an EPROM or PROM) and associated socket, a thumb drive and USB port, and other removable storage units 3718 and interfaces 3714 which allow software and data to be transferred from removable storage unit 3718 to computer system 3700.

Computer system 3700 may also include a communications interface 3720. Communications interface 3720 allows software and data to be transferred between computer system 3700 and external devices. Examples of communications interface 3720 may include a modem, a network interface (such as an Ethernet card), a communications port, etc. Software and data transferred via communications interface 3720 are in the form of signals which may be electronic, electromagnetic, optical, or other signals capable of being received by communications interface 3720. These signals are provided to communications interface 3720 via a communications path 3722. Communications path 3722 carries signals and may be implemented using wire or cable, fiber optics, a phone line, a cellular phone link, an RF link, and other communications channels.

Computer system 3700 may also include one or more sensor(s) 3724. Sensor(s) 3724 may measure or detect one or more physical quantities and convert the measured or detected physical quantities into an electrical signal in digital and/or analog form. For example, sensor(s) 3724 may include an eye tracking sensor to track the eye movement of a user. Based on the eye movement of a user, a display of a point cloud may be updated. In another example, sensor(s) 3724 may include a head tracking sensor to the track the head movement of a user. Based on the head movement of a user, a display of a point cloud may be updated. In yet another example, sensor(s) 3724 may include a camera sensor for taking photographs and/or a 3D scanning device, like a laser scanning, structured light scanning, and/or modulated light scanning device. 3D scanning devices may determine geometry information by moving one or more laser heads, structured light, and/or modulated light cameras relative to the object or scene being scanned. The geometry information may be used to construct a point cloud.

As used herein, the terms “computer program medium” and “computer readable medium” are used to refer to tangible storage media, such as removable storage units 3716 and 3718 or a hard disk installed in hard disk drive 3710. These computer program products are means for providing software to computer system 3700. Computer programs (also called computer control logic) may be stored in main memory 3706 and/or secondary memory 3708. Computer programs may also be received via communications interface 3720. Such computer programs, when executed, enable the computer system 3700 to implement the present disclosure as discussed herein. In particular, the computer programs, when executed, enable processor 3704 to implement the processes of the present disclosure, such as any of the methods described herein. Accordingly, such computer programs represent controllers of the computer system 3700.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
decoding, from a bitstream, attribute coding unit (ACU) information indicating a segmentation of a reconstructed geometry of a slice, of slices of TriSoup nodes representing a geometry of a point cloud, into a set of ACUs, wherein an ACU, of the set of ACUs, corresponds to at least one TriSoup node of TriSoup nodes of the slice;
segmenting, according to the ACU information, the reconstructed geometry of the slice of the point cloud into the set of ACUs, wherein each of the ACUs comprises at least one point of the point cloud; and
decoding attributes of points, of the point cloud, belonging to a current ACU of the set of ACUs before decoding attributes of points, of the point cloud, belonging to another ACU of the set of ACUs.

2. The method of claim 1, wherein the set of ACUs is ordered according to an ACU coding order, and wherein the attributes of the points belonging to the current ACU in the set of ordered ACUs are decoded before decoding attributes of points of the point cloud belonging to a next ACU in the set of ordered ACUs.

3. The method of claim 2, wherein the ACU coding order comprises a raster scan order used for scanning nodes of a slice of the point cloud.

4. The method of claim 1, wherein the decoding the attributes of points belonging to the current ACU comprises:
determining predicted attributes of the points of the current ACU based on attributes of points of at least one already-decoded ACU;
decoding, from the bitstream, residual attributes of the points of the current ACU; and
determining decoded attributes of the points of the current ACU based on adding the predicted attributes to the residual attributes.

5. The method of claim 4, wherein the determining the predicted attributes is based on an average of attributes of the at least one already-coded ACU.

6. The method of claim 4, further comprising decoding, from the bitstream, an indication of an ACU attribute coding mode from a plurality of ACU attribute coding modes comprising:
a first ACU attribute coding mode indicating the at least one already-coded ACU is of the set of ACUs and belongs to a same point cloud frame as the current point cloud frame; and
a second ACU attribute coding mode indicating the current ACU belongs to a current point cloud frame and the at least one already-coded ACU belongs to an already-coded point cloud frame different from the current point cloud frame.

7. The method of claim 6, wherein the plurality of ACU attribute coding modes further comprises a third ACU attribute coding mode indicating the attributes of the points of the current ACU are decoded independently of any already-coded ACUs.

8. A decoder comprising:
one or more processors; and
memory storing instructions that, when executed by the one or more processors, cause the decoder to:
decode, from a bitstream, attribute coding unit (ACU) information indicating a segmentation of a reconstructed geometry of a slice, of slices of TriSoup nodes representing a geometry of a point cloud, into a set of ACUs, wherein an ACU, of the set of ACUs, corresponds to at least one TriSoup node of TriSoup nodes of the slice;
segment, according to the ACU information, the reconstructed geometry of the slice of the point cloud into the set of ACUs, wherein each of the ACUs comprises at least one point of the point cloud; and
decode attributes of points, of the point cloud, belonging to a current ACU of the set of ACUs before decoding attributes of points, of the point cloud, belonging to another ACU of the set of ACUs.

9. The decoder of claim 8, wherein the set of ACUs is ordered according to an ACU coding order, and wherein the attributes of the points belonging to the current ACU in the set of ordered ACUs are decoded before decoding attributes of points of the point cloud belonging to a next ACU in the set of ordered ACUs.

10. The decoder of claim 9, wherein the ACU coding order comprises a raster scan order used for scanning nodes of a slice of the point cloud.

11. The decoder of claim 8, wherein to decode the attributes of points belonging to the current ACU, the instructions further cause the decoder to:
determine predicted attributes of the points of the current ACU based on attributes of points of at least one already-decoded ACU;
decode, from the bitstream, residual attributes of the points of the current ACU; and
determine decoded attributes of the points of the current ACU based on adding the predicted attributes to the residual attributes.

12. The decoder of claim 11, wherein the determination of the predicted attributes is based on an average of attributes of the at least one already-coded ACU.

13. The decoder of claim 11, wherein the instructions further cause the decoder to decode, from the bitstream, an indication of an ACU attribute coding mode from a plurality of ACU attribute coding modes comprising:
a first ACU attribute coding mode indicating the at least one already-coded ACU is of the set of ACUs and belongs to a same point cloud frame as the current point cloud frame; and
a second ACU attribute coding mode indicating the current ACU belongs to a current point cloud frame and the at least one already-coded ACU belongs to an already-coded point cloud frame different from the current point cloud frame.

14. The decoder of claim 13, wherein the plurality of ACU attribute coding modes further comprises a third ACU attribute coding mode indicating the attributes of the points of the current ACU are decoded independently of any already-coded ACUs.

15. A non-transitory computer-readable medium comprising instructions that, when executed by one or more processors of a decoder, cause the decoder to:
decode, from a bitstream, attribute coding unit (ACU) information indicating a segmentation of a reconstructed geometry of a slice, of slices of TriSoup nodes representing a geometry of a point cloud, into a set of ACUs, wherein an ACU, of the set of ACUs, corresponds to at least one TriSoup node of TriSoup nodes of the slice;
segment, according to the ACU information, the reconstructed geometry of the slice of the point cloud into the set of ACUs, wherein each of the ACUs comprises at least one point of the point cloud; and
decode attributes of points, of the point cloud, belonging to a current ACU of the set of ACUs before decoding attributes of points, of the point cloud, belonging to another ACU of the set of ACUs.

16. The non-transitory computer-readable medium of claim 15, wherein the set of ACUs is ordered according to an ACU coding order, and wherein the attributes of the points belonging to the current ACU in the set of ordered ACUs are decoded before decoding attributes of points of the point cloud belonging to a next ACU in the set of ordered ACUs.

17. The non-transitory computer-readable medium of claim 16, wherein the ACU coding order comprises a raster scan order used for scanning nodes of a slice of the point cloud.

18. The non-transitory computer-readable medium of claim 15, wherein to decode the attributes of points belonging to the current ACU, the instructions further cause the decoder to:
determine predicted attributes of the points of the current ACU based on attributes of points of at least one already-decoded ACU;
decode, from the bitstream, residual attributes of the points of the current ACU; and
determine decoded attributes of the points of the current ACU based on adding the predicted attributes to the residual attributes.

19. The non-transitory computer-readable medium of claim 18, wherein the determination of the predicted attributes is based on an average of attributes of the at least one already-coded ACU.

20. The non-transitory computer-readable medium of claim 18, wherein the instructions further cause the decoder to decode, from the bitstream, an indication of an ACU attribute coding mode from a plurality of ACU attribute coding modes comprising:
a first ACU attribute coding mode indicating the at least one already-coded ACU is of the set of ACUs and belongs to a same point cloud frame as the current point cloud frame; and
a second ACU attribute coding mode indicating the current ACU belongs to a current point cloud frame and the at least one already-coded ACU belongs to an already-coded point cloud frame different from the current point cloud frame.
